(19) United States
(12) Patent Application Publication
(10) Pub. No.: US 2022/0330373 A1
(43) Pub. Date: Oct. 13, 2022

(54) SUBSCRIPTION CHANGE PROCESSING METHOD, DEVICE, AND SYSTEM

(71) Applicant: HUAWEI TECHNOLOGIES CO., LTD., Shenzhen (CN)

(72) Inventors: Haiyang SUN, Beijing (CN); Yan LI, Beijing (CN); Hui NI, Beijing (CN)

(73) Assignee: HUAWEI TECHNOLOGIES CO., LTD., Shenzhen (CN)

(21) Appl. No.: 17/851,368

(22) Filed: Jun. 28, 2022

Related U.S. Application Data
(63) Continuation of application No. PCT/CN2019/130205, filed on Dec. 30, 2019.

(51) Int. Cl. H04W 76/19; H04W 8/18

(52) U.S. Cl. CPC H04W 76/19; H04W 8/18; H04W 80/10

(57) ABSTRACT

Embodiment of this application provides a subscription change processing method, a first session management network element receives first indication information, where the first indication information indicates that a plurality of sessions of a terminal device need to be managed by using a same session management network element, the plurality of sessions are a plurality of sessions that each have: a first DNN and first S-NSSAI, and the first session management network element is one of a plurality of session management network elements corresponding to the plurality of sessions. The first session management network element sends a session release notification to the terminal device, where the session release notification carries a first session identifier and second indication information, the second indication information indicates to re-establish a first session corresponding to the first session identifier, and the first session is a session that has: the first DNN and the first S-NSSAI.

### CROSS-REFERENCE TO RELATED APPLICATIONS

This application is a continuation of International Application No. PCT/CN2019/130205, filed on Dec. 30, 2019, the disclosure of which is hereby incorporated by reference in its entirety.

### TECHNICAL FIELD

This application relates to the field of communication technologies, and in particular, to a subscription change processing method, a device, and a system.

### BACKGROUND

Currently, for some characteristics of policy control, it is usually required that protocol data unit (packet data unit, PDU) sessions that have same attributes: a same data network name (data network name, DNN) and a same piece of single network slice selection assistance information (Single Network Slice Selection Assistance Information, S-NSSAI) be operated by using a same control network element. For example, usage management is to ensure that a resource used by PDU sessions that correspond to a terminal device and that have same attributes: a same DNN and a same piece of S-NSSAI does not exceed a maximum value. Therefore, a unified policy control function (policy control function, PCF) network element is required to perform an operation.

To select a same PCF network element for the PDU sessions that have the same attributes: the same DNN and the same piece of S-NSSAI, in a conventional technology, when a PCF network element requests to register with a binding support function (binding support function, BSF) network element after a session management function (session management function, SMF) network element selects the PCF network element for PDU sessions that each have specific attributes: a specific DNN and a specific piece of S-NSSAI, if the BSF network element does not have registration information of another PCF network element, the PCF network element registers with the BSF network element; otherwise, the BSF network element returns an existing PCF ID to a current PCF network element, the current PCF network element sends the received PCF ID to the SMF network element, and the SMF network element selects a new PCF network element based on the PCF ID.

In addition, because the BSF network element may not be centrally deployed, but may be co-deployed with the SMF network element, different SMF network elements may still select different PCF network elements. Therefore, subscription information may be added to a unified data management (unified data management, UDM) network element, to indicate an access and mobility management function (access and mobility management function, AMF) network element to select a same SMF network element for the PDU sessions that each have the specific attributes: the specific DNN and the specific piece of S-NSSAI. A manner in which the AMF network element selects the same SMF network element for the PDU sessions that each have the specific attributes: the specific DNN and the specific piece of S-NSSAI is similar to the foregoing manner in which the SMF network element selects the same SMF network element for the PDU sessions that each have the specific attributes: the specific DNN and the specific piece of S-NSSAI. Details are not described herein again.

However, after a PDU session has been established, if subscription data of a terminal device is updated from that a same control network element (for example, an SMF network element or a PCF network element) does not need to be selected to that the same control network element needs to be selected, a current mechanism cannot satisfy a requirement of selecting the same control network element for the PDU sessions that have the same attributes: the same DNN and the same piece of S-NSSAI.

### SUMMARY

Embodiments of this application provide a subscription change processing method, a device, and a system, to resolve a problem that a current mechanism cannot satisfy a requirement of selecting a same control network element for PDU sessions that have same attributes: a same DNN and a same piece of S-NSSAI.

To achieve the foregoing objective, the following technical solutions are used in embodiments of this application.

According to a first aspect, a subscription change processing method is provided. The method includes: A first session management network element receives first indication information, where the first indication information indicates that a plurality of sessions of a terminal device need to be managed by using a same session management network element, the plurality of sessions are a plurality of sessions that each have attributes: a first data network name DNN and first single network slice selection assistance information S-NSSAI, and the first session management network element is one of a plurality of session management network elements corresponding to the plurality of sessions. The first session management network element sends a session release notification to the terminal device, where the session release notification carries a first session identifier and second indication information, the second indication information indicates to re-establish a first session corresponding to the first session identifier, and the first session is a session that has the attributes: the first DNN and the first S-NSSAI. Based on this solution, after a session has been established, if subscription data of a terminal device is updated to that a plurality of sessions of the terminal device need to be managed by using a same session management network element, the corresponding session management network element may trigger the terminal device to re-establish the corresponding sessions, to select the same session management network element for the sessions that have same attributes: a same DNN and a same piece of S-NSSAI.

With reference to the first aspect, in a possible implementation, the second indication information is that the plurality of sessions need to be managed by using the same session management network element.

According to a second aspect, a subscription change processing method is provided. The method includes:

A first policy control network element receives fourth indication information from a first session management network element, where the fourth indication information indicates that a plurality of sessions of a terminal device need to be managed by using a same session management network element, the plurality of sessions are a plurality of sessions that each have attributes: a first data network name DNN and first single network slice selection assistance information S-NSSAI, the first session management network element is one of a plurality of session management network elements corresponding to the plurality of sessions, and the first policy control network element is one of a plurality of policy control network elements corresponding to the plurality of sessions. The first policy control network element obtains an identifier of a second policy control network element from a binding support function network element, and sends the identifier of the second policy control network element to the first session management network element, where the second policy control network element is a policy control network element selected for a session that has the attributes: the first DNN and the first S-NSSAI, and the identifier of the second policy control network element is used to indicate to reselect, to the second policy control network element, a policy control network element that serves a session that has the attributes: the first DNN and the first S-NSSAI. Based on this solution, after a session has been established, if subscription data of a terminal device is updated to that a plurality of sessions of the terminal device need to be managed by using a same session management network element, the corresponding session management network element may trigger, by using a policy control network element associated with the session management network element, a binding support function network element to reselect a policy control network element, to select a same policy control network element for the sessions that have same attributes: a same DNN and a same piece of S-NSSAI.

With reference to the second aspect, in a possible implementation, a quantity of established sessions that correspond to the second policy control network element and that each have the attributes: the first DNN and the first S-NSSAI is not less than a quantity of established sessions that correspond to any other one of the plurality of policy control network elements corresponding to the plurality of sessions and that each have the attributes: the first DNN and the first S-NSSAI. In this way, changes of policy control network elements corresponding to excessive sessions can be avoided to a greatest extent, so that a procedure is more optimized.

With reference to the second aspect, in a possible implementation, the subscription change processing method provided in this embodiment of this application further includes: The first session management network element receives the identifier of the second policy control network element from the first policy control network element. The first session management network element selects, based on the identifier of the second policy control network element, the second policy control network element to serve the session that has the attributes: the first DNN and the first S-NSSAI.

With reference to the second aspect, in a possible implementation, the subscription change processing method provided in this embodiment of this application further includes: The first session management network element releases a policy association with the first policy control network element, and establishing a policy association with the second policy control network element.

With reference to the second aspect, in a possible implementation, the subscription change processing method provided in this embodiment of this application further includes: The first session management network element receives a first subscription request message from the first policy control network element, where the first subscription request message is used to request a first event, and the first event is an event that subscription data of the terminal device changes. In other words, in this embodiment of this application, when the subscription data of the terminal device changes, the first session management network element may send the fourth indication information to the first policy control network element based on subscription of the first policy control network element.

With reference to the second aspect, in a possible implementation, the subscription change processing method provided in this embodiment of this application further includes: The first session management network element receives first indication information, where the first indication information indicates that the plurality of sessions of the terminal device need to be managed by using the same session management network element. The first session management network element sends the fourth indication information to one or more policy control network elements associated with the first session management network element, where the one or more policy control network elements are one or more of the plurality of policy control network elements corresponding to the plurality of sessions, and the one or more policy control network elements include the first policy control network element.

According to a third aspect, a subscription change processing method is provided. The method includes: A first session management network element receives first indication information, where the first indication information indicates that a plurality of sessions of a terminal device need to be managed by using a same session management network element, the plurality of sessions are a plurality of sessions that each have attributes: a first data network name DNN and first single network slice selection assistance information S-NSSAI, and the first session management network element is one of a plurality of session management network elements corresponding to the plurality of sessions. The first session management network element releases one or more policy associations with one or more policy control network elements associated with the first session management network element, and establishes a policy association with a target policy control network element, where the one or more policy control network elements are one or more of a plurality of policy control network elements corresponding to the plurality of sessions, and the target policy control network element is a policy control network element reselected for one or more sessions that are established by using the one or more policy control network elements and that each have the attributes: the first DNN and the first S-NSSAI. Based on this solution, after a session has been established, if subscription data of a terminal device is updated to that a plurality of sessions of the terminal device need to be managed by using a same session management network element, the corresponding session management network element may reselect a policy control network element, to select a same policy control network element for the sessions that have same attributes: a same DNN and a same piece of S-NSSAI.

With reference to the third aspect, in a possible implementation, the target policy control network element is one of the plurality of policy control network elements corresponding to the plurality of sessions, and the one or more policy control network elements are one or more policy control network elements other than the target policy control network element in the plurality of policy control network elements corresponding to the plurality of sessions.

With reference to the third aspect, in a possible implementation, a quantity of established sessions that correspond to the target policy control network element and that each have the attributes: the first DNN and the first S-NSSAI is not less than a quantity of established sessions that correspond to any one of the one or more policy control network elements and that each have the attributes: the first DNN and the first S-NSSAI. In this way, changes of policy control network elements corresponding to excessive sessions can be avoided to a greatest extent, so that a procedure is more optimized.

With reference to the first aspect, the second aspect, or the third aspect, in a possible implementation, that a first session management network element receives first indication information includes: The first session management network element receives the first indication information from a unified data management network element.

With reference to the first aspect, the second aspect, or the third aspect, in a possible implementation, the subscription change processing method provided in this embodiment of this application further includes: The first session management network element sends a second subscription request message to the unified data management network element, where the second subscription request message is used to request to subscribe to a second event, and the second event is an event that the subscription data of the terminal device changes. In this way, when the subscription data of the terminal device changes, the unified data management network element may send the first indication information to the first session management network element based on subscription of the first session management network element.

With reference to the first aspect, the second aspect, or the third aspect, in a possible implementation, the subscription change processing method provided in this embodiment of this application further includes: The unified data management network element determines that the plurality of sessions of the terminal device need to be managed by using the same session management network element. The unified data management network element sends the first indication information to one or more session management network elements, where the one or more session management network elements are one or more of the plurality of session management network elements corresponding to the plurality of sessions, and the one or more session management network elements include the first session management network element.

With reference to the first aspect, the second aspect, or the third aspect, in a possible implementation, the subscription change processing method provided in this embodiment of this application further includes: The unified data management network element determines that the plurality of sessions have been established by using a plurality of session management network elements.

With reference to the first aspect, the second aspect, or the third aspect, in a possible implementation, that a first session management network element receives first indication information includes: The first session management network element receives the first indication information from a mobility management network element.

With reference to the first aspect, the second aspect, or the third aspect, in a possible implementation, the subscription change processing method provided in this embodiment of this application further includes: The first session management network element sends a third subscription request message to the mobility management network element, where the third subscription request message is used to request to subscribe to a third event, and the third event is an event that the subscription data of the terminal device changes. In this way, when the subscription data of the terminal device changes, the mobility management network element may send the first indication information to the first session management network element based on subscription of the first session management network element.

With reference to the first aspect, the second aspect, or the third aspect, in a possible implementation, the subscription change processing method provided in this embodiment of this application further includes: The mobility management network element receives third indication information from a unified data management network element, where the third indication information indicates that the plurality of sessions of the terminal device need to be managed by using the same session management network element. The mobility management network element sends the first indication information to one or more session management network elements based on the third indication information, where the one or more session management network elements are one or more of the plurality of session management network elements corresponding to the plurality of sessions, and the one or more session management network elements include the first session management network element.

With reference to the first aspect, the second aspect, or the third aspect, in a possible implementation, the subscription change processing method provided in this embodiment of this application further includes: The mobility management network element sends a fourth subscription request message to the unified data management network element, where the fourth subscription request message is used to request to subscribe to a fourth event, and the fourth event is an event that the subscription data of the terminal device changes. In this way, when the subscription data of the terminal device changes, the unified data management network element may send the third indication information to the mobility management network element based on subscription of the mobility management network element.

With reference to the first aspect, the second aspect, or the third aspect, in a possible implementation, the subscription change processing method provided in this embodiment of this application further includes: The mobility management network element determines that the plurality of sessions have been established by using a plurality of session management network elements.

With reference to the first aspect, the second aspect, or the third aspect, in a possible implementation, the one or more session management network elements are one or more session management network elements other than a second session management network element in the plurality of session management network elements corresponding to the plurality of sessions.

With reference to the first aspect, the second aspect, or the third aspect, in a possible implementation, a quantity of established sessions that correspond to the second session management network element and that each have the attributes: the first DNN and the first S-NSSAI is not less than a quantity of established sessions that correspond to any one of the one or more session management network elements and that each have the attributes: the first DNN and the first S-NSSAI. In this way, release and re-establishment of excessive sessions can be avoided to a greatest extent, so that a procedure is more optimized.

According to a fourth aspect, a subscription change processing method is provided. The method includes: A unified data management network element determines that a plurality of sessions of a terminal device need to be managed by using a same session management network element, where the plurality of sessions are a plurality of sessions that each have attributes: a first data network name DNN and first single network slice selection assistance information S-NSSAI. The unified data management network element sends fifth indication information, where the fifth indication information indicates that the plurality of sessions of the terminal device need to be managed by using the same session management network element.

With reference to the fourth aspect, in a possible implementation, that the unified data management network element sends fifth indication information includes: The unified data management network element sends the fifth indication information to a mobility management network element.

With reference to the fourth aspect, in a possible implementation, the subscription change processing method provided in this embodiment of this application further includes: The unified data management network element receives a fourth subscription request message from the mobility management network element, where the fourth subscription request message is used to request to subscribe to a fourth event, and the fourth event is an event that subscription data of the terminal device changes.

With reference to the fourth aspect, in a possible implementation, that the unified data management network element sends fifth indication information includes: The unified data management network element sends the fifth indication information to one or more session management network elements, where the one or more session management network elements are one or more of a plurality of session management network elements corresponding to the plurality of sessions.

With reference to the fourth aspect, in a possible implementation, the subscription change processing method provided in this embodiment of this application further includes: The unified data management network element determines that the plurality of sessions have been established by using a plurality of session management network elements.

With reference to the fourth aspect, in a possible implementation, the one or more session management network elements are one or more session management network elements other than a second session management network element in the plurality of session management network elements corresponding to the plurality of sessions.

With reference to the fourth aspect, in a possible implementation, a quantity of established sessions that correspond to the second session management network element and that each have the attributes: the first DNN and the first S-NSSAI is not less than a quantity of established sessions that correspond to any one of the one or more session management network elements and that each have the attributes: the first DNN and the first S-NSSAI.

With reference to the fourth aspect, in a possible implementation, the subscription change processing method provided in this embodiment of this application further includes: The unified data management network element receives a second subscription request message from the one or more session management network elements, where the second subscription request message is used to request to subscribe to a first event, and the second event is an event that the subscription data of the terminal device changes. Based on this solution, after a session has been established, if subscription data of a terminal device is updated to that a plurality of sessions of the terminal device need to be managed by using a same session management network element, a same session management network element or a same policy control network element may be selected for sessions that have same attributes: a same DNN and a same piece of S-NSSAI. For analysis of related technical effects, refer to the first aspect, the second aspect, or the third aspect. Details are not described herein again.

According to a fifth aspect, a communication apparatus is provided to implement the foregoing methods. The communication apparatus may be the first session management network element in the first aspect or the third aspect or an apparatus including the first session management network element. Alternatively, the communication apparatus may be the first policy control network element in the second aspect or an apparatus including the first policy control network element. Alternatively, the communication apparatus may be the unified data management network element in the fourth aspect or an apparatus including the unified data management network element. The communication apparatus includes a corresponding module, unit, or means (means) for implementing the foregoing methods. The module, unit, or means may be implemented by using hardware or software, or implemented by hardware executing corresponding software. The hardware or the software includes one or more modules or units corresponding to the foregoing functions.

According to a sixth aspect, a communication apparatus is provided, and includes a processor and a memory. The memory is configured to store computer instructions. When the processor executes the instructions, the communication apparatus is enabled to perform the method according to any one of the foregoing aspects. The communication apparatus may be the first session management network element in the first aspect or the third aspect or an apparatus including the first session management network element. Alternatively, the communication apparatus may be the first policy control network element in the second aspect or an apparatus including the first policy control network element. Alternatively, the communication apparatus may be the unified data management network element in the fourth aspect or an apparatus including the unified data management network element.

According to a seventh aspect, a communication apparatus is provided, and includes a processor. The processor is configured to: after being coupled to a memory and reading instructions in the memory, perform, according to the instructions, the method according to any one of the foregoing aspects. The communication apparatus may be the first session management network element in the first aspect or the third aspect or an apparatus including the first session management network element. Alternatively, the communication apparatus may be the first policy control network element in the second aspect or an apparatus including the first policy control network element. Alternatively, the communication apparatus may be the unified data management network element in the fourth aspect or an apparatus including the unified data management network element.

According to an eighth aspect, a computer-readable storage medium is provided. The computer-readable storage medium stores instructions. When the instructions are run on a computer, the computer is enabled to perform the method according to any one of the foregoing aspects.

According to a ninth aspect, a computer program product including instructions is provided. When the computer program product runs on a computer, the computer is enabled to perform the method according to any one of the foregoing aspects.

According to a tenth aspect, a communication apparatus (for example, the communication apparatus may be a chip or a chip system) is provided. The communication apparatus includes a processor. The processor is configured to implement the functions in any one of the foregoing aspects. In a possible implementation, the communication apparatus further includes a memory. The memory is configured to store program instructions and data that are necessary. When the communication apparatus is a chip system, the communication apparatus may include a chip, or may include the chip and another discrete component.

For technical effects brought by any design manner in the fifth aspect to the tenth aspect, refer to the technical effects brought by different design manners in the first aspect to the fourth aspect. Details are not described herein again.

According to an eleventh aspect, a communication system is provided. The communication system includes a unified data management network element, a mobility management network element, and a first session management network element. The unified data management network element is configured to determine that a plurality of sessions of a terminal device need to be managed by using a same session management network element, where the plurality of sessions are a plurality of sessions that each have attributes: a first data network name DNN and first single network slice selection assistance information S-NSSAI. The unified data management network element is further configured to send third indication information to the mobility management network element, where the third indication information indicates that the plurality of sessions of the terminal device need to be managed by using the same session management network element. The mobility management network element is configured to receive the third indication information from the unified data management network element, and send first indication information to the first session management network element, where the first indication information indicates that the plurality of sessions of the terminal device need to be managed by using the same session management network element, and the first session management network element is one of a plurality of session management network elements corresponding to the plurality of sessions. The first session management network element is configured to receive the first indication information, and send a session release notification to the terminal device, where the session release notification carries a first session identifier and second indication information, the second indication information indicates to re-establish a first session corresponding to the first session identifier, and the first session is a session that has the attributes: the first DNN and the first S-NSSAI. For technical effects of the eleventh aspect, refer to the first aspect. Details are not described herein again.

With reference to the eleventh aspect, in a possible implementation, the mobility management network element is further configured to determine that the plurality of sessions have been established by using a plurality of session management network elements.

According to a twelfth aspect, a communication system is provided. The communication system includes a unified data management network element and a first session management network element. The unified data management network element is configured to determine that a plurality of sessions of a terminal device need to be managed by using a same session management network element, where the plurality of sessions are a plurality of sessions that each have attributes: a first data network name DNN and first single network slice selection assistance information S-NSSAI. The unified data management network element is further configured to send first indication information to the first session management network element, where the first indication information indicates that the plurality of sessions of the terminal device need to be managed by using the same session management network element, and the first session management network element is one of a plurality of session management network elements corresponding to the plurality of sessions. The first session management network element is configured to receive the first indication information, and send a session release notification to the terminal device, where the session release notification carries a first session identifier and second indication information, the second indication information indicates to re-establish a first session corresponding to the first session identifier, and the first session is a session that has the attributes: the first DNN and the first S-NSSAI. For technical effects of the twelfth aspect, refer to the first aspect. Details are not described herein again.

With reference to the twelfth aspect, in a possible implementation, the unified data management network element is further configured to determine that the plurality of sessions have been established by using a plurality of session management network elements.

According to a thirteenth aspect, a communication system is provided. The communication system includes a first policy control network element and a first session management network element. The first session management network element is configured to receive first indication information, where the first indication information indicates that a plurality of sessions of a terminal device need to be managed by using a same session management network element, the plurality of sessions are a plurality of sessions that each have attributes: a first data network name DNN and first single network slice selection assistance information S-NSSAI, and the first session management network element is one of a plurality of session management network elements corresponding to the plurality of sessions. The first session management network element is further configured to send fourth indication information to the first policy control network element, where the fourth indication information indicates that the plurality of sessions of the terminal device need to be managed by using the same session management network element, and the first policy control network element is one of a plurality of policy control network elements corresponding to the plurality of sessions. The first policy control network element is configured to receive the fourth indication information from the first session management network element, and obtain an identifier of a second policy control network element from a binding support function network element, where the second policy control network element is a policy control network element selected for a session that has the attributes: the first DNN and the first S-NSSAI. The first policy control network element is further configured to send the identifier of the second policy control network element to the first session management network element. The first session management network element is further configured to receive the identifier of the second policy control network element from the first policy control network element, and select, based on the identifier of the second policy control network element, the second policy control network element to serve the session that has the attributes: the first DNN and the first S-NSSAI. For technical effects of the thirteenth aspect, refer to the second aspect. Details are not described herein again.

With reference to the thirteenth aspect, in a possible implementation, the first session management network element is further configured to release a policy association with the first policy control network element, and establish a policy association with the second policy control network element.

### BRIEF DESCRIPTION OF DRAWINGS

FIG. 1 is a schematic diagram of a scenario in which an AMF network element respectively selects different SMF network elements for different PDU sessions that have same attributes: a same DNN and a same piece of S-NSSAI and the different SM network elements select different and PCF network elements for the PDU session according to a conventional technology;

FIG. 2 is a schematic diagram of a PDU session establishment procedure according to a conventional technology;

FIG. 3 is a schematic diagram of an architecture of a communication system according to an embodiment of this application;

FIG. 4 is a schematic diagram of an architecture of another communication system according to an embodiment of this application;

FIG. 5 is a schematic diagram of an architecture of still another communication system according to an embodiment of this application;

FIG. 6 is a schematic diagram 1 of a 5G network architecture according to an embodiment of this application;

FIG. 7 is a schematic diagram 2 of a 5G network architecture according to an embodiment of this application;

FIG. 8 is a schematic diagram of a structure of a communication device according to an embodiment of this application;

FIG. 9 is a schematic flowchart 1 of a subscription change processing method according to an embodiment of this application;

FIG. 10 is a schematic flowchart 2 of a subscription change processing method according to an embodiment of this application;

FIG. 11 is a schematic flowchart 3 of a subscription change processing method according to an embodiment of this application;

FIG. 12 is a schematic flowchart 4 of a subscription change processing method according to an embodiment of this application;

FIG. 13 is a schematic diagram 1 of a structure of a first session management network element according to an embodiment of this application;

FIG. 14 is a schematic diagram 2 of a structure of a first session management network element according to an embodiment of this application;

FIG. 15 is a schematic diagram of a structure of a first policy control network element according to an embodiment of this application; and

FIG. 16 is a schematic diagram of a structure of a unified data management network element according to an embodiment of this application.

### DESCRIPTION OF EMBODIMENTS

For ease of understanding solutions in embodiments of this application, related concepts are first briefly described as follows.

1. PDU Session

The PDU session is an association between a terminal device and a data network (data network, DN), and is used to provide a PDU connection service. In embodiments of this application, each session in the following embodiments may be the PDU session. This is uniformly described herein. Details are not described below again.

2. Selection of an SMF Network Element and a PCF Network Element

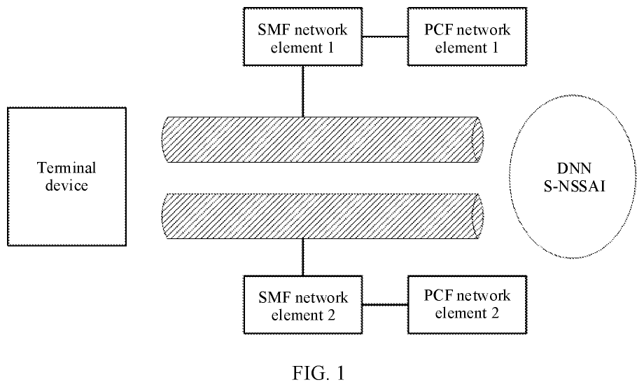

According to an existing standard, an AMF network element may select different SMF network elements for PDU sessions that have same attributes: a same DNN and a same piece of S-NSSAI, and the different SMF network elements may select different PCF network elements for the PDU sessions that have the same attributes: the same DNN and the same piece of S-NSSAI. As shown in FIG. 1, an AMF network element respectively selects an SMF network element 1 and an SMF network element 2 for different PDU sessions that have same attributes: a same DNN and a same piece of S-NSSAI, the SMF network element 1 selects a PCF network element 1 for a corresponding PDU session, and the SMF network element 2 selects a PCF network element 2 for a corresponding PDU session.

A procedure in which the AMF network element interacts with a network function repository function (network function repository function, NRF) to obtain information about an SMF network element and select the SMF network element may be as follows.

When a terminal device is located in a home public land mobile network (home public land mobile network, HPLMN), the AMF network element is located in the HPLMN. The AMF network element sends a network function (network function, NF) discovery request to an NRF network element in the HPLMN. The network function discovery request includes information such as a DNN and S-NSSAI, and is used to obtain information (for example, an internet protocol (internet protocol, IP) address (which may be an IP version 4 (version 4, IPv4) address or an IP version 6 (version 6, IPv6) prefix) or a fully qualified domain name (fully qualified domain name, FQDN) of an SMF network element in the HPLMN) about the SMF network element. Further, the AMF network element selects the SMF network element based on the obtained information about the SMF network element. If the DNN is not used for interworking, the AMF network element may select different SMF network elements for PDU sessions that have same attributes: a same DNN and a same piece of S-NSSAL

When a terminal device is located in a visited public land mobile network (visited public land mobile network, VPLMN), the AMF network element is also located in the VPLMN. In this scenario, in case of a home routed (home routed) scenario, the AMF network element needs to select two SMF network elements, namely, a visited SMF (visited SMF, vSMF) network element and a home SMF (home SMF, hSMF) network element. Specifically, the AMF network element sends an NF discovery request to a visited NRF (visited NRF, vNRF) network element. The NF discovery request includes information such as a DNN and S-NSSAI, and is used to obtain information about an SMF network element in the VPLMN. Further, the AMF network element selects the vSMF network element based on the obtained information about the SMF network elements in the VPLMN. Further, the AMF network element sends an NF discovery request to a home NRF (home NRF, hNRF) network element by using the vNRF. The NF discovery request includes information such as a DNN and S-NSSAI, and is used to obtain information about an SMF network element in the HPLMN. Further, the AMF network element selects the hSMF network element based on the obtained information about the SMF network element in the HPLMN. Certainly, in case of a local breakout (local breakout) scenario, the AMF network element only needs to select a vSMF network element. Specifically, the AMF network element sends an NF discovery request to an NRF network element in the VPLMN. The NF discovery request includes information such as a DNN and S-NSSAI, and is used to obtain information about an SMF network element in the VPLMN. Further, the AMF network element selects the vSMF network element based on the obtained information about the SMF network element.

To select a same SMF network element for the PDU sessions that have the same attributes: the same DNN and the same piece of S-NSSAI, in a conventional technology, when the SMF network element requests to register with a BSF network element after the AMF network element selects the SMF network element for PDU sessions that each have specific attributes: a specific DNN and a specific piece of S-NSSAI, if the BSF network element does not have registration information of another SMF network element, the SMF network element registers with the BSF network element; otherwise, the BSF network element returns an existing SMF ID to a current SMF network element, the current SMF network element sends the received SMF ID to the AMF network element, and the AMF network element selects a new SMF network element based on the SMF ID.

A procedure in which the SMF network element interacts with the NRF network element to obtain information about a PCF network element and select the PCF network element may be as follows.

First, when the SMF network element selects the PCF network element, the SMF network element and the PCF network element are definitely located in a same PLMN. That is, both the SMF network element and the PCF network element are located in an HPLMN in a non-roaming scenario. In a local breakout scenario, both the SMF network element and the PCF network element are located in a VPLMN. In a home routed scenario, only an hSMF needs to select an hPCF network element. That is, both the hSMF and the hPCF network element are located in the HPLMN.

Specifically, the SMF network element sends an NF discovery request to the NRF network element. The NF discovery request includes information such as a DNN and S-NSSAI, and is used to obtain information (for example, an IP address (which may be an IPv4 address or an IPv6 prefix) or an FQDN of the PCF network element) about the PCF network element. Further, the SMF network element selects the PCF network element based on the obtained information about the PCF network element. If the DNN is not used for interworking, the SMF network element may select different PCF network elements for PDU sessions that have same attributes: a same DNN and a same piece of S-NSSAI. To select a same PCF network element for the PDU sessions that have the same attributes: the same DNN and the same piece of S-NSSAI, in a conventional technology, when the PCF network element requests to register with a BSF network element after the SMF network element selects the PCF network element for PDU sessions that each have specific attributes: a specific DNN and a specific piece of S-NSSAI, if the BSF network element does not have registration information of another PCF network element, the PCF network element registers with the BSF network element; otherwise, the BSF network element returns an existing PCF ID to a current PCF network element, the current PCF network element sends the received PCF ID to the SMF network element, and the SMF network element selects a new PCF network element based on the PCF ID.

3. PDU Session Establishment Procedure

Because the PDU session establishment procedure is an existing procedure, related steps are merely briefly described by using an example in embodiments of this application. For a detailed implementation procedure, refer to the existing PDU session establishment procedure.

Details are not described herein.

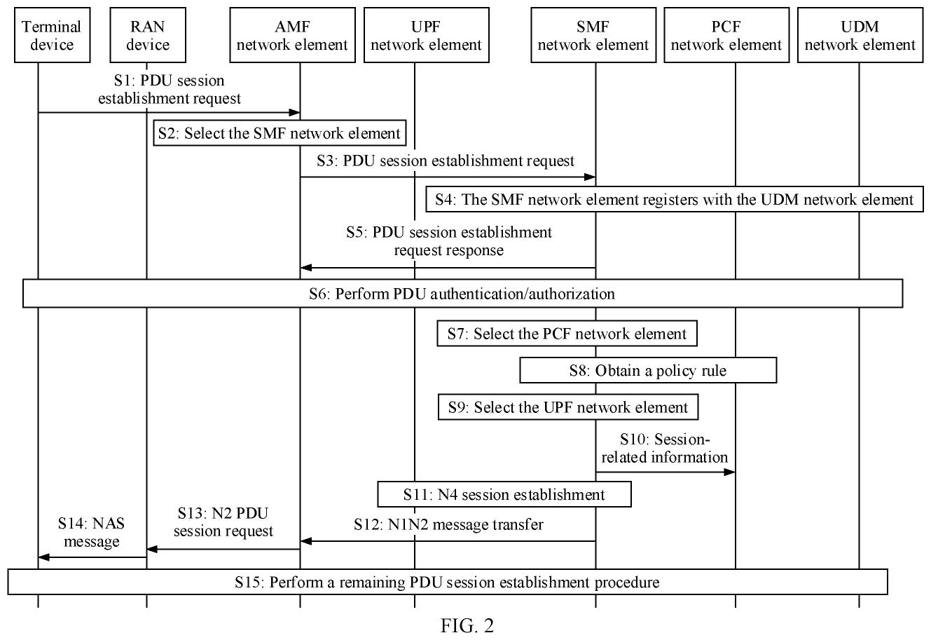

FIG. 2 shows an existing PDU session establishment procedure. The procedure includes the following steps.

S1: A terminal device sends a PDU session establishment request to an AMF network element. Correspondingly, the AMF network element receives the PDU session establishment request from the terminal device.

S2: The AMF network element selects an SMF network element. For an implementation, refer to the foregoing selection of the SMF network element. Details are not described herein again.

S3: The AMF network element sends a PDU session establishment request to the SMF network element. Correspondingly, the SMF network element receives the PDU session establishment request from the AMF network element.

S4: The SMF network element registers with a UDM network element, and obtains subscription information from the UDM network element.

S5: The SMF network element sends a PDU session establishment request response to the AMF network element. Correspondingly, the AMF network element receives the PDU session establishment request response from the SMF network element.

Optionally, the SMF network element may alternatively reject PDU session establishment in this step. For details, refer to a conventional technology. Details are not described herein.

S6: Perform PDU session authentication/authorization.

S7: The SMF selects a PCF network element. For an implementation, refer to the foregoing selection of the PCF network element. Details are not described herein again.

S8: The SMF network element obtains a policy rule from the PCF network element.

S9: The SMF network element selects a UPF network element.

S10: The SMF network element reports session-related information, for example, an IP address or prefix of the terminal device and a status of a trigger, to the PCF network element.

S11: N4 session establishment.

S12: The SMF network element sends N1N2 message transfer to the AMF network element. Correspondingly, the AMF network element receives the N1N2 message transfer from the SMF network element.

The N1N2 message transfer includes a PDU session identifier, N2 session management (session management, SM) information, and an N1 SM container (N1 SM container). The N2 SM information is sent to a radio access network (radio access network, RAN) device, and the AMF network element only forwards the N2 SM information. The N1 SM container is sent to the terminal device, and both the RAN device and the AMF network element transparently transmit the N1 SM container.

S13: The AMF network element sends an N2 PDU session request to the RAN device. Correspondingly, the RAN device receives the N2 PDU session request from the AMF network element.

The N2 PDU session request includes the N2 SM information and a non-access stratum (NAS) message. The NAS message may be, for example, a PDU session establishment accept message. The NAS message includes the N1 SM container.

S14: The RAN device sends a NAS message to the terminal device. Correspondingly, the terminal device receives the NAS message from the RAN device.

S15: Perform a remaining PDU session establishment procedure, which is irrelevant to embodiments of this application. Details are not described herein.

The following describes the technical solutions in embodiments of this application with reference to accompanying drawings in embodiments of this application. In descriptions of this application, unless otherwise specified, “I” represents an “or” relationship between associated objects. For example, A/B may represent A or B. In this application, “and/or” describes only an association relationship between associated objects and represents that three relationships may exist. For example, A and/or B may represent the following three cases: Only A exists, both A and B exist, and only B exists, where A or B may be singular or plural. In addition, in the descriptions of this application, “a plurality of” means two or more than two, unless otherwise specified. “At least one of the following” or a similar expression thereof means any combination of these items, and includes a singular item or any combination of plural items. For example, at least one of a, b, or c may represent a, b, c, a combination of a and b, a combination of a and c, a combination of b and c, or a combination of a, b, and c, where a, b, and c may be in a singular or plural form. In addition, to clearly describe the technical solutions in embodiments of this application, terms such as “first” and “second” are used in embodiments of this application to distinguish between same items or similar items that have basically same functions and purposes. A person skilled in the art may understand that the terms such as “first” and “second” do not limit a quantity or an execution sequence, and the terms such as “first” and “second” do not indicate a definite difference. In addition, in embodiments of this application, the word such as “exemplary” or “for example” is used to represent giving an example, an illustration, or a description. Any embodiment or design scheme described as “exemplary” or “for example” in embodiments of this application should not be explained as being more preferred or having more advantages than another embodiment or design scheme. Exactly, use of the word such as “exemplary” or “for example” is intended to present a related concept in a specific manner for ease of understanding.

In addition, network architectures and service scenarios described in embodiments of this application are intended to describe the technical solutions in embodiments of this application more clearly, and do not constitute a limitation on the technical solutions provided in embodiments of this application. A person of ordinary skill in the art may learn that with evolution of the network architectures and emergence of new service scenarios, the technical solutions provided in embodiments of this application are also applicable to similar technical problems.

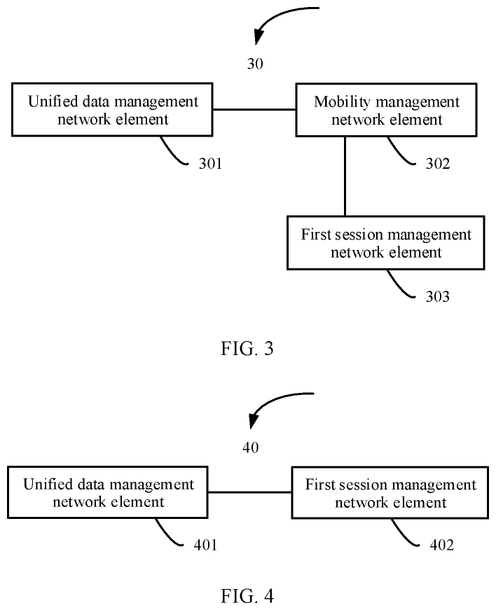

FIG. 3 shows a communication system 30 according to an embodiment of this application. The communication system 30 includes a unified data management network element 301, a mobility management network element 302, and a first session management network element 303. The mobility management network element 302 and the unified data management network element 301 or the first session management network element 303 may directly communicate with each other, or may communicate with each other through forwarding performed by another device. This is not specifically limited in this embodiment of this application.

The unified data management network element 301 is configured to determine that a plurality of sessions of a terminal device need to be managed by using a same session management network element, where the plurality of sessions are a plurality of sessions that each have attributes: a first DNN and first S-NSSAI. The unified data management network element 301 is further configured to send third indication information to the mobility management network element 302, where the third indication information indicates that the plurality of sessions of the terminal device need to be managed by using the same session management network element. The mobility management network element 302 is configured to receive the third indication information from the unified data management network element 301, and send first indication information to the first session management network element 303, where the first indication information indicates that the plurality of sessions of the terminal device need to be managed by using the same session management network element, and the first session management network element 303 is one of a plurality of session management network elements corresponding to the plurality of sessions. The first session management network element 303 is configured to receive the first indication information, and send a session release notification to the terminal device, where the session release notification carries a first session identifier and second indication information, the second indication information indicates to re-establish a first session corresponding to the first session identifier, and the first session is a session that has the attributes: the first DNN and the first S-NSSAI. A specific implementation of the foregoing solution is described in detail in subsequent method embodiments. Details are not described herein.

Based on the communication system provided in this embodiment of this application, after a session has been established, if subscription data of a terminal device is updated to that a plurality of sessions of the terminal device need to be managed by using a same session management network element, the corresponding session management network element may trigger the terminal device to re-establish the corresponding sessions, to select the same session management network element for the sessions that have same attributes: a same DNN and a same piece of S-NSSAI.

FIG. 4 shows another communication system 40 according to an embodiment of this application. The communication system 40 includes a unified data management network element 401 and a first session management network element 402. The unified data management network element 401 and the first session management network element 402 may directly communicate with each other, or may communicate with each other through forwarding performed by another device. This is not specifically limited in this embodiment of this application.

The unified data management network element 401 is configured to determine that a plurality of sessions of a terminal device need to be managed by using a same session management network element, where the plurality of sessions are a plurality of sessions that each have attributes: a first DNN and first S-NSSAI. The unified data management network element 401 is further configured to send first indication information to the first session management network element 402, where the first indication information indicates that the plurality of sessions of the terminal device need to be managed by using the same session management network element, and the first session management network element 402 is one of a plurality of session management network elements corresponding to the plurality of sessions. The first session management network element 402 is configured to receive the first indication information, and send a session release notification to the terminal device, where the session release notification carries a first session identifier and second indication information, the second indication information indicates to re-establish a first session corresponding to the first session identifier, and the first session is a session that has the attributes: the first DNN and the first S-NSSAI. A specific implementation of the foregoing solution is described in detail in subsequent method embodiments. Details are not described herein.

Based on the communication system provided in this embodiment of this application, after a session has been established, if subscription data of a terminal device is updated to that a plurality of sessions of the terminal device need to be managed by using a same session management network element, the corresponding session management network element may trigger the terminal device to re-establish the corresponding sessions, to select the same session management network element for the sessions that have same attributes: a same DNN and a same piece of S-NSSAI.

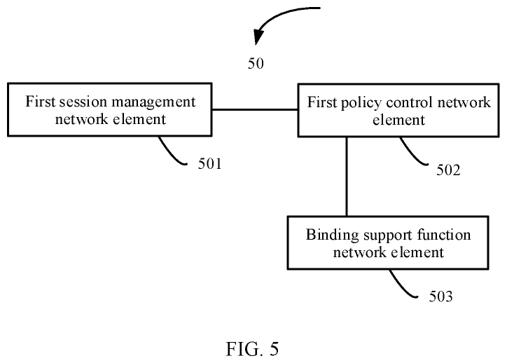

FIG. 5 shows another communication system 50 according to an embodiment of this application. The communication system 50 includes a first session management network element 501, a first policy control network element 502, and a binding support function network element 503. The first policy control network element 502 and the first session management network element 501 or the binding support function network element 503 may directly communicate with each other, or may communicate with each other through forwarding performed by another device. This is not specifically limited in this embodiment of this application.

The first session management network element 501 is configured to receive first indication information, where the first indication information indicates that a plurality of sessions of a terminal device need to be managed by using a same session management network element, the plurality of sessions are a plurality of sessions that each have attributes: a first DNN and first S-NSSAI, and the first session management network element is one of a plurality of session management network elements corresponding to the plurality of sessions. The first session management network element 501 is further configured to send fourth indication information to the first policy control network element 502, where the fourth indication information indicates that the plurality of sessions of the terminal device need to be managed by using the same session management network element, and the first policy control network element 502 is one of a plurality of policy control network elements corresponding to the plurality of sessions. The first policy control network element 502 is configured to receive the fourth indication information from the first session management network element 501, and obtain an identifier of a second policy control network element from the binding support function network element 503, where the second policy control network element is a policy control network element selected for a session that has the attributes: the first DNN and the first S-NSSAI. The first policy control network element 502 is further configured to send the identifier of the second policy control network element to the first session management network element 501. The first session management network element 501 is further configured to receive the identifier of the second policy control network element from the first policy control network element 502, and select, based on the identifier of the second policy control network element, the second policy control network element to serve the session that has the attributes: the first DNN and the first S-NSSAI. A specific implementation of the foregoing solution is described in detail in subsequent method embodiments. Details are not described herein.

Based on the communication system provided in this embodiment of this application, after a session has been established, if subscription data of a terminal device is updated to that a plurality of sessions of the terminal device need to be managed by using a same session management network element, the corresponding session management network element may trigger, by using a policy control network element associated with the session management network element, a binding support function network element to reselect a policy control network element, to select a same policy control network element for the sessions that have same attributes: a same DNN and a same piece of S-NSSAI.

Optionally, the communication system 30 shown in FIG. 3, the communication system 40 shown in FIG. 4, or the communication system 50 shown in FIG. 5 may be used in a currently discussed 5th generation (5th generation, 5G) network, another future network, or the like. This is not specifically limited in embodiments of this application.

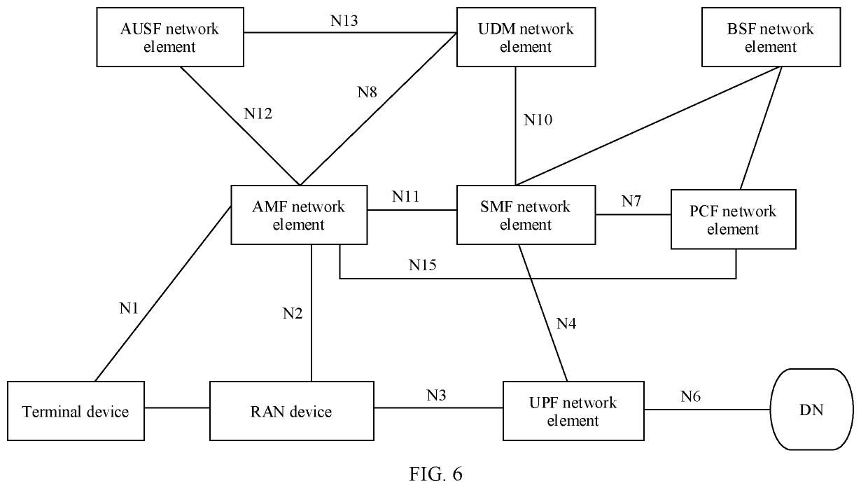

For example, it is assumed that the communication system 30 shown in FIG. 3, the communication system 40 shown in FIG. 4, or the communication system 50 shown in FIG. 5 is used in a 5G network architecture in a non-roaming scenario. As shown in FIG. 6, a network element or an entity corresponding to the unified data management network element may be a UDM network element in the non-roaming 5G network architecture, a network element or an entity corresponding to the mobility management network element may be an AMF network element in the non-roaming 5G network architecture, a network element or an entity corresponding to the first session management network element may be an SMF network element in the non-roaming 5G network architecture, a network element or an entity corresponding to the first policy control network element may be a PCF network element in the non-roaming 5G network architecture, and a network element or an entity corresponding to the binding support function network element may be a BSF network element in the non-roaming 5G network architecture.

In addition, as shown in FIG. 6, the non-roaming 5G network architecture may further include a RAN device, an authentication server function (authentication server function, AUSF) network element, or some other network elements that are not shown, for example, an NRF network element. This is not specifically limited in this embodiment of this application.

A terminal device communicates with the AMF network element through a next generation (next generation, N) 1 interface (N1 for short). The RAN device communicates with the AMF network element through an N2 interface (N2 for short). The RAN device communicates with a UPF network element through an N3 interface (N3 for short). The UPF network element communicates with a DN through an N6 interface (N6 for short). The AMF network element communicates with the SMF network element through an N11 interface (N11 for short). The AMF network element communicates with the UDM network element through an N8 interface (N8 for short). The AMF network element communicates with the AUSF network element through an N12 interface (N12 for short). The AMF network element communicates with the PCF network element through an N15 interface (N15 for short). The SMF network element communicates with the PCF network element through an N7 interface (N7 for short). The SMF network element communicates with the UPF network element through an N4 interface (N4 for short). The SMF network element communicates with the UDM network element through an N10 interface (N10 for short). The UDM network element communicates with the AUSF network element through an N13 interface (N13 for short). Both the PCF network element and the SMF network element may communicate with the BSF network element.

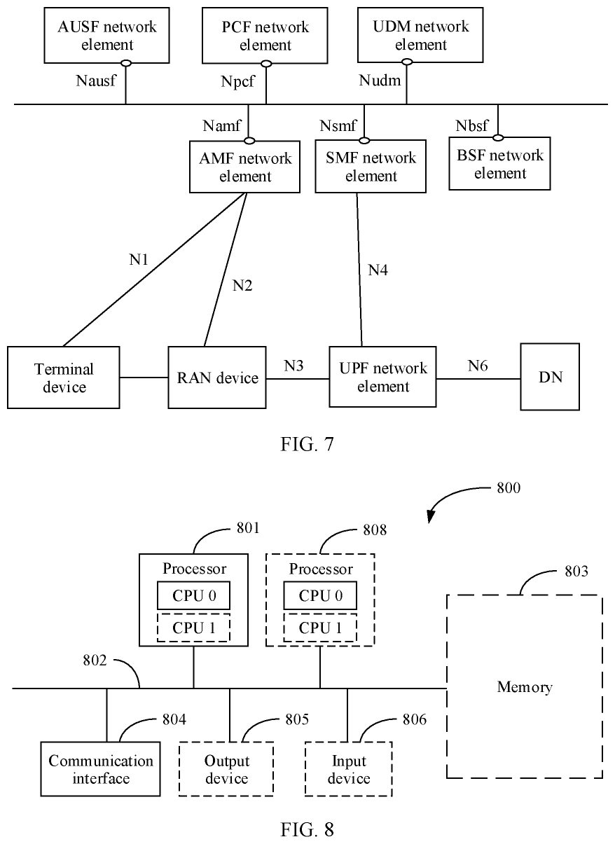

In addition, it should be noted that control plane network elements such as the AMF network element, the SMF network element, the UDM network element, the AUSF network element, the BSF network element, and the PCF network element in the non-roaming 5G network architecture shown in FIG. 6 may alternatively interact with each other through service-oriented interfaces. For example, as shown in FIG. 7, an external service-oriented interface provided by the AMF network element may be Namf, an external service-oriented interface provided by the SMF network element may be Nsmf, an external service-oriented interface provided by the UDM network element may be Nudm, an external service-oriented interface provided by the PCF network element may be Npcf, an external service-oriented interface provided by the BSF network element may be Nbsf, and an external service-oriented interface provided by the AUSF network element may be Nausf. For related descriptions, refer to a 5G system architecture (5G system architecture) in the standard 23.501. Details are not described herein.

Certainly, the communication system 30 shown in FIG. 3, the communication system 40 shown in FIG. 4, or the communication system 50 shown in FIG. 5 may alternatively be used in a 5G network architecture in a local breakout (local breakout) roaming scenario or a 5G network architecture in a home routed (home routed) roaming scenario. In this case, only adaptive replacement needs to be performed on related network elements. Details are not described herein one by one.

Optionally, the terminal device in embodiments of this application may be a device configured to implement a wireless communication function, for example, a terminal or a chip that may be used in the terminal. The terminal may be user equipment (user equipment, UE), an access terminal, a terminal unit, a terminal station, a mobile station, a remote station, a remote terminal, a mobile device, a wireless communication device, a terminal agent, a terminal apparatus, or the like in the 5G network or a future evolved PLMN. The access terminal may be a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device or another processing device connected to a wireless modem, a vehicle-mounted device, a wearable device, a virtual reality (virtual reality, VR) terminal device, an augmented reality (augmented reality, AR) terminal device, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), or the like. The terminal may be mobile or at a fixed location.

Optionally, the RAN device in embodiments of this application is a device that accesses a core network. For example, the RAN device may be a base station, a broadband network gateway (broadband network gateway, BNG), an aggregation switch, or a non-3rd generation partnership project (3rd generation partnership project, 3GPP) access device. There may be various forms of base stations, for example, a macro base station, a micro base station (also referred to as a small cell), a relay station, and an access point.

Optionally, the unified data management network element, the mobility management network element, the first session management network element, the first policy control network element, or the binding support function network element in embodiments of this application may also be referred to as a communication apparatus, and may be a general-purpose device or a dedicated device. This is not specifically limited in embodiments of this application.

Optionally, a related function of the unified data management network element, the mobility management network element, the first session management network element, the first policy control network element, or the binding support function network element in embodiments of this application may be implemented by one device, may be jointly implemented by a plurality of devices, or may be implemented by one or more function modules in the device. This is not specifically limited in embodiments of this application. It may be understood that the foregoing function may be a network element in a hardware device, a software function running on dedicated hardware, a combination of hardware and software, or a virtualization function instantiated on a platform (for example, a cloud platform).

For example, a related function of the unified data management network element, the mobility management network element, the first session management network element, the first policy control network element, or the binding support function network element in embodiments of this application may be implemented by using a communication device (which may also be referred to as a communication apparatus) 800 in FIG. 8. FIG. 8 is a schematic diagram of a structure of a communication device 800 according to an embodiment of this application. The communication device 800 includes one or more processors 801, a communication line 802, and at least one communication interface (in FIG. 8, only an example in which a communication interface 804 and one processor 801 are included is used for description). Optionally, the communication device 800 may further include a memory 803.

The processor 801 may be a general-purpose central processing unit (central processing unit, CPU), a microprocessor, an application-specific integrated circuit (application-specific integrated circuit, ASIC), or one or more integrated circuits configured to control program execution of the solutions in this application.

The communication line 802 may include a path configured to connecting different components.

The communication interface 804 may be a transceiver module configured to communicate with another device or a communication network, for example, the Ethernet, a RAN, or a wireless local area network (wireless local area networks, WLAN). For example, the transceiver module may be an apparatus such as a transceiver or a transceiver. Optionally, the communication interface 804 may alternatively be a transceiver circuit located in the processor 801, to implement signal input and signal output of the processor.

The memory 803 may be an apparatus having a storage function. For example, the memory 803 may be a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (electrically erasable programmable read-only memory, EEPROM), a compact disc read-only memory (compact disc read-only memory, CD-ROM) or another optical disk storage, an optical disc storage (including a compact disc, a laser disc, an optical disc, a digital versatile disc, a Blu-ray disc, or the like), a disk storage medium or another magnetic storage device, or any other medium that can be used to carry or store expected program code in a form of instructions or a data structure and that can be accessed by a computer. However, the memory 803 is not limited thereto. The memory may exist alone, and is connected to the processor through the communication line 802. Alternatively, the memory may be integrated with the processor.

The memory 803 is configured to store computer-executable instructions for executing the solutions in this application, and the processor 801 controls the execution. The processor 801 is configured to execute the computer-executable instructions stored in the memory 803, to implement the subscription change processing method provided in embodiments of this application.

Alternatively, optionally, in this embodiment of this application, the processor 801 may implement a processing-related function in the subscription change processing method provided in the following embodiments of this application, and the communication interface 804 may be responsible for communicating with the another device or the communication network. This is not specifically limited in this embodiment of this application.

Optionally, the computer-executable instructions in this embodiment of this application may also be referred to as application program code. This is not specifically limited in this embodiment of this application.

During specific implementation, in an embodiment, the processor 801 may include one or more CPUs, for example, a CPU 0 and a CPU 1 in FIG. 8.

During specific implementation, in an embodiment, the communication device 800 may include a plurality of processors, for example, the processor 801 and a processor 808 in FIG. 8. Each of the processors may be a single-core (single-core) processor or a multi-core (multi-core) processor. The processor herein may include but is not limited to at least one of the following various computing devices that run software: a central processing unit (central processing unit, CPU), a microprocessor, a digital signal processor (DSP), a microcontroller unit (microcontroller unit, MCU), an artificial intelligence processor, or the like. Each computing device may include one or more cores configured to perform an operation or processing by executing software instructions.

During specific implementation, in an embodiment, the communication device 800 may further include an output device 805 and an input device 806. The output device 805 communicates with the processor 801, and may display information in a plurality of manners. For example, the output device 805 may be a liquid crystal display (liquid crystal display, LCD), a light emitting diode (light emitting diode, LED) display device, a cathode ray tube (cathode ray tube, CRT) display device, or a projector (projector). The input device 806 communicates with the processor 801, and may receive input of a user in a plurality of manners. For example, the input device 806 may be a mouse, a keyboard, a touchscreen device, a sensor device, or the like.

The communication device 800 may also be referred to as the communication apparatus sometimes, and may be a general-purpose device or a dedicated device. For example, the communication device 800 may be a desktop computer, a portable computer, a network server, a personal digital assistant (personal digital assistant, PDA), a mobile phone, a tablet computer, a wireless terminal device, an embedded device, the foregoing terminal device, the foregoing network device, or a device having a structure similar to the structure shown in FIG. 8. A type of the communication device 800 is not limited in this embodiment of this application.

The subscription change processing method provided in embodiments of this application is specifically described with reference to FIG. 1 to FIG. 8.

It should be noted that names of messages between the network elements, names of parameters in the messages, or the like in the following embodiments of this application are merely examples, and there may alternatively be other names during specific implementation. This is not specifically limited in embodiments of this application.

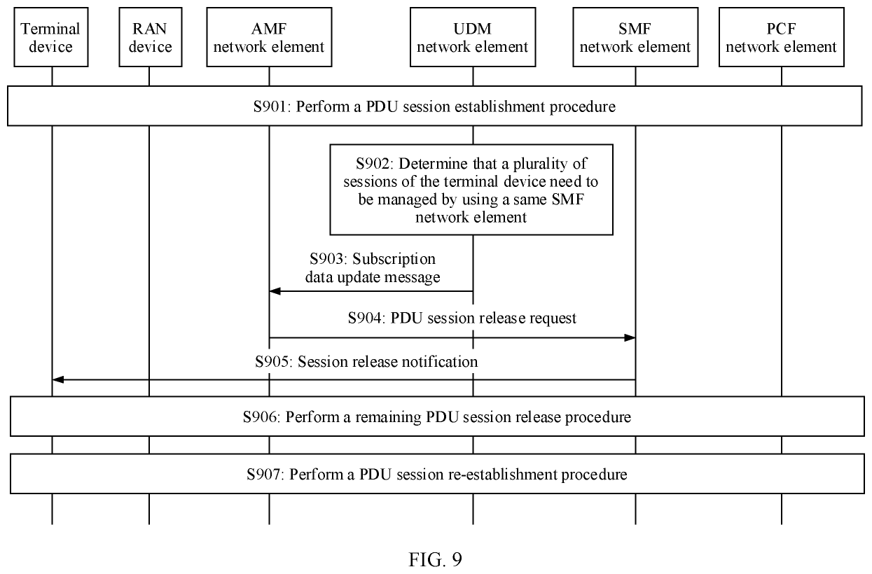

First, for example, the communication system shown in FIG. 3 is used in the 5G network architecture in the non-roaming scenario shown in FIG. 6 or FIG. 7. FIG. 9 shows a subscription change processing method according to an embodiment of this application. The subscription change processing method includes the following steps.

S901: Perform a PDU session establishment procedure. Refer to the PDU session establishment procedure shown in FIG. 2. Details are not described herein again.

S902: After a PDU session is established, the UDM network element determines that a plurality of sessions of a terminal device need to be managed by using a same SMF network element, where the plurality of sessions are a plurality of sessions that each have attributes: a first DNN and first S-NSSAI.

S903: The UDM network element sends a subscription data update (subscription data update) message to the AMF network element. Correspondingly, the AMF network element receives the subscription data update message from the UDM network element.

The subscription data update message carries indication information 1, and the indication information 1 indicates that the plurality of sessions of the terminal device need to be managed by using the same SMF network element.

Optionally, the indication information 1 in this embodiment of this application may also be referred to as third indication information. This is not specifically limited in this embodiment of this application.

Optionally, in this embodiment of this application, before the AMF network element receives the subscription data update message from the UDM network element, the AMF network element may send a fourth subscription request message to the UDM network element, where the fourth subscription request message is used to request to subscribe to a fourth event, and the fourth event is an event that subscription data of the terminal device changes. This is not specifically limited in this embodiment of this application.

S904: The AMF network element sends a PDU session release request to the SMF network element. Correspondingly, the SMF network element receives the PDU session release request from the AMF network element.

The PDU session release request carries indication information 2, and the indication information 2 indicates that the plurality of sessions of the terminal device need to be managed by using the same SMF network element.

Certainly, in this embodiment of this application, the PDU session release request may further carry a first session identifier. The first session identifier is used to identify a to-be-released first session. The first session is a session that has the attributes: the first DNN and the first S-NS SAI. This is not specifically limited in this embodiment of this application.

Optionally, the indication information 2 may be a session re-establishment indication, or may be a special cause value, and is used to indicate that the plurality of sessions of the terminal device need to be managed by using the same SMF network element. This is not specifically limited in this embodiment of this application. Certainly, during implementation, the cause value may mean that a subscription changes to “the plurality of sessions of the terminal device need to be managed by using the same SMF network element”; the cause value may be a notification that is sent by the AMF network element to the SMF network element and that is of a subscription change: “the plurality of sessions of the terminal device need to be managed by using the same SMF network element”; or the cause value may indicate that PDU session re-establishment to a same DN is required (cause indicating that a PDU Session re-establishment to the same DN is required). This is not specifically limited in this embodiment of this application.

Optionally, the indication information 2 in this embodiment of this application may also be referred to as first indication information. This is not specifically limited in this embodiment of this application.

Optionally, in this embodiment of this application, before the SMF network element receives the PDU session release request from the AMF network element, the SMF network element may send a third subscription request message to the AMF network element, where the third subscription request message is used to request to subscribe to a third event, and the third event is an event that the subscription data of the terminal device changes. This is not specifically limited in this embodiment of this application.

Optionally, in this embodiment of this application, after receiving the subscription data update message from the UDM network element, the AMF network element may first determine whether the plurality of sessions (namely, the plurality of sessions) that each have the attributes: the first DNN and the first S-NSSAI are managed by using the same SMF network element. When the AMF network element determines that the plurality of sessions that each have the attributes: the first DNN and first S-NSSAI are managed by a plurality of SMF network elements (that is, the plurality of sessions have been established by using the plurality of SMF network elements), the AMF network element sends one or more PDU session release requests to one or more SMF network elements. In FIG. 9, interaction between the AMF network element and one SMF network element is used as an example for description. If the AMF network element needs to interact with a plurality of SMF network elements, for a procedure of interaction between the AMF network element and another SMF network element, refer to step S904. Details are not described herein again. Certainly, in this embodiment of this application, when the AMF network element determines that the plurality of sessions that each have the attributes: the first DNN and the first S-NSSAI are managed by using the same SMF network element (that is, one or more sessions have been established by using one SMF network element), subsequent processing does not need to be performed because a requirement raised after the subscription data changes is satisfied. This is uniformly described herein. Details are not described below again.

Optionally, in this embodiment of this application, the one or more SMF network elements interacting with the AMF network element may be all of a plurality of SMF network elements corresponding to the plurality of sessions, or may be one or more SMF network elements other than a specific SMF network element in the plurality of SMF network elements corresponding to the plurality of sessions. That is, during implementation, a session on the specific SMF network element may be retained and not released. When a session is re-established subsequently, the AMF network element may select the SMF network element for a session that has the attributes: the first DNN and the first S-NSSAI. For example, the specific SMF network element herein may be an SMF network element corresponding to a largest quantity of established sessions that each have the attributes: the first DNN and the first S-NSSAI. That is, a quantity of established sessions that correspond to the SMF network element and that each have the attributes: the first DNN and the first S-NSSAI is not less than a quantity of established sessions that correspond to any one of the one or more SMF network elements and that each have the attributes: the first DNN and the first S-NSSAI. In this way, release and re-establishment of excessive sessions can be avoided to a greatest extent, so that a procedure is more optimized.

Optionally, to implement the foregoing solution, in this embodiment of this application, after the SMF network element establishes a policy association with a specific PCF network element, the SMF network element may send a PCF ID of the selected PCF network element to the AMF network element, so that the AMF network element records a mapping relationship between a PDU session identifier and the PCF ID. This is not specifically limited in this embodiment of this application.

S905: The SMF network element releases the first session based on the PDU session release request, and sends a session release notification to the terminal device. Correspondingly, the terminal device receives the session release notification from the SMF network element.

The session release notification carries the first session identifier and indication information 3, and the indication information 3 indicates to re-establish the first session corresponding to the first session identifier.

Optionally, in this embodiment of this application, the indication information 3 may be that the plurality of sessions need to be managed by using the same SMF network element. This is not specifically limited in this embodiment of this application.

Optionally, the indication information 3 may be a special cause value. During implementation, the cause value may mean that the subscription changes to “the plurality of sessions of the terminal device need to be managed by using the same SMF network element”; the cause value may be the notification that is sent by the AMF network element to the SMF network element and that is of the subscription change: “the plurality of sessions of the terminal device need to be managed by using the same SMF network element”; or the cause value may indicate that the PDU session re-establishment to the same DN is required (cause indicating that a PDU Session re-establishment to the same DN is required). This is not specifically limited in this embodiment of this application.

Optionally, the indication information 3 in this embodiment of this application may also be referred to as second indication information. This is not specifically limited in this embodiment of this application.

It should be understood that the indication information 1, the indication information 2, and the indication information 3 may be the same, or may be different. This is not specifically limited in this embodiment of this application.

S906: Perform a remaining PDU session release procedure. For details, refer to a conventional technology. Details are not described herein.

S907: The terminal device initiates, based on the session release notification, a procedure of re-establishing the first session corresponding to the first session identifier. For specific implementation, refer to the PDU session establishment procedure shown in FIG. 2. Details are not described herein again.

It should be noted that, in this embodiment of this application, the re-established PDU session is a session corresponding to the first session. That is, a session identifier of the re-established PDU session is not necessarily the same as the session identifier of the first session. However, at least one of other attributes (for example, a DNN, a session and service continuity (session and service continuity, SSC) mode, and S-NSSAI) and the like of the re-established PDU session should be consistent with those of the first session. Optionally, when initiating a session establishment request for the re-established PDU session, the terminal device may carry both the identifier of the first session and the session identifier of the newly established PDU session to indicate an association relationship between the first session and the newly established PDU session. This is not specifically limited in this embodiment of this application.

In steps S904 to S907, descriptions are provided by using an example in which the first session established by using the SMF network element is released and re-established. It should be understood that there may be a plurality of sessions that are established by using the SMF network element and that each have the attributes: the first DNN and the first S-NSSAI. For a release and re-establishment procedure of another session, refer to steps S904 to S907. Details are not described herein again.

Based on the subscription change processing method provided in this embodiment of this application, after a session has been established, if subscription data of a terminal device is updated to that a plurality of sessions of the terminal device need to be managed by using a same SMF network element, the corresponding SMF network element may trigger the terminal device to re-establish the corresponding sessions, to select the same SMF network element for the sessions that have same attributes: a same DNN and a same piece of S-NSSAI.

Actions of the SMF network element, the AMF network element, or the UDM network element in steps S901 to S907 may be performed by the processor 801 in the communication device 800 shown in FIG. 8 by invoking the application program code stored in the memory 803. This is not limited in this embodiment.

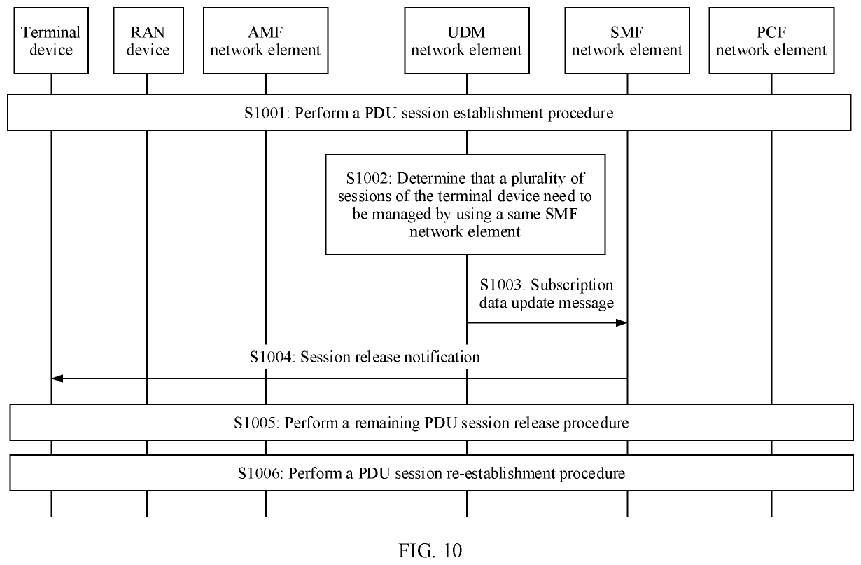

Optionally, for example, the communication system shown in FIG. 4 is used in the 5G network architecture in the non-roaming scenario shown in FIG. 6 or FIG. 7. FIG. 10 shows another subscription change processing method according to an embodiment of this application. The subscription change processing method includes the following steps.

S1001 and S1002: Steps S1001 and S1002 are the same as steps S901 and S902 in the embodiment shown in FIG. 9. For related descriptions, refer to the embodiment shown in FIG. 9. Details are not described herein again.

S1003: The UDM network element sends a subscription data update (subscription data update) message to the SMF network element. Correspondingly, the SMF network element receives the subscription data update message from the UDM network element.

The subscription data update message carries indication information 4, and the indication information 4 indicates that the plurality of sessions of the terminal device need to be managed by using the same SMF network element.

Optionally, the indication information 4 may be a special cause value. During implementation, the cause value may mean that a subscription changes to “the plurality of sessions of the terminal device need to be managed by using the same SMF network element”; the cause value may be a notification that is sent by an AMF network element to the SMF network element and that is of a subscription change: “the plurality of sessions of the terminal device need to be managed by using the same SMF network element”; or the cause value may indicate that PDU session re-establishment to a same DN is required (cause indicating that a PDU Session re-establishment to the same DN is required). This is not specifically limited in this embodiment of this application.

Optionally, the indication information 4 in this embodiment of this application may also be referred to as first indication information. This is not specifically limited in this embodiment of this application.

Optionally, in this embodiment of this application, before the SMF network element receives the subscription data update message from the UDM network element, the SMF network element may send a second subscription request message to the UDM network element, where the second subscription request message is used to request to subscribe to a second event, and the second event is an event that subscription data of the terminal device changes. This is not specifically limited in this embodiment of this application.

Optionally, in this embodiment of this application, the UDM network element may further send a subscription data update message to the AMF network element, although this is not shown. For related descriptions, refer to step S903 in the embodiment shown in FIG. 9. Details are not described herein again.

Optionally, in this embodiment of this application, after determining that the plurality of sessions of the terminal device need to be managed by using the same SMF network element, the UDM network element may first determine whether the plurality of sessions (namely, the plurality of sessions) that each have the attributes: the first DNN and the first S-NSSAI are managed by using the same SMF network element. When the UDM network element determines that the plurality of sessions that each have the attributes: the first DNN and the first S-NSSAI are managed by a plurality of SMF network elements (that is, the plurality of sessions have been established by using the plurality of SMF network elements), the UDM network element sends one or more subscription data update messages to one or more SMF network elements. In FIG. 10, interaction between the UDM network element and one SMF network element is used as an example for description. If the UDM network element needs to interact with a plurality of SMF network elements, for a procedure of interaction between the UDM network element and another SMF network element, refer to step S1003. Details are not described herein again.

Optionally, in this embodiment of this application, the one or more SMF network elements interacting with the UDM network element may be all of a plurality of SMF network elements corresponding to the plurality of sessions, or may be one or more SMF network elements other than a specific SMF network element in the plurality of SMF network elements corresponding to the plurality of sessions. That is, during implementation, a session on the specific SMF network element may be retained and not released (that is, the UDM network element does not need to send a subscription data update message to the SMF network element). When a session is re-established subsequently, and when the AMF network element learns that the subscription changes to “the plurality of sessions of the terminal device need to be managed by using the same SMF network element”, the SMF network element may be selected for a session that has the attributes: the first DNN and the first S-NSSAI. For example, the specific SMF network element herein may be an SMF network element corresponding to a largest quantity of established sessions that each have the attributes: the first DNN and the first S-NSSAI. That is, a quantity of established sessions that correspond to the SMF network element and that each have the attributes: the first DNN and the first S-NSSAI is not less than a quantity of established sessions that correspond to any one of the one or more SMF network elements and that each have the attributes: the first DNN and the first S-NSSAI. In this way, release and re-establishment of excessive sessions can be avoided to a greatest extent, so that a procedure is more optimized.

S1004 to S1006: Steps S1004 to S1006 are the same as steps S905 to S907 in the embodiment shown in FIG. 9. For related descriptions, refer to the embodiment shown in FIG. 9. Details are not described herein again.

It should be understood that the indication information 4 and the indication information 3 may be the same, or may be different. This is not specifically limited in this embodiment of this application.

Based on the subscription change processing method provided in this embodiment of this application, after a session has been established, if subscription data of a terminal device is updated to that a plurality of sessions of the terminal device need to be managed by using a same SMF network element, the corresponding SMF network element may trigger the terminal device to re-establish the corresponding sessions, to select the same SMF network element for the sessions that have same attributes: a same DNN and a same piece of S-NSSAI.

Actions of the SMF network element or the UDM network element in steps S1001 to S1006 may be performed by the processor 801 in the communication device 800 shown in FIG. 8 by invoking the application program code stored in the memory 803. This is not limited in this embodiment.

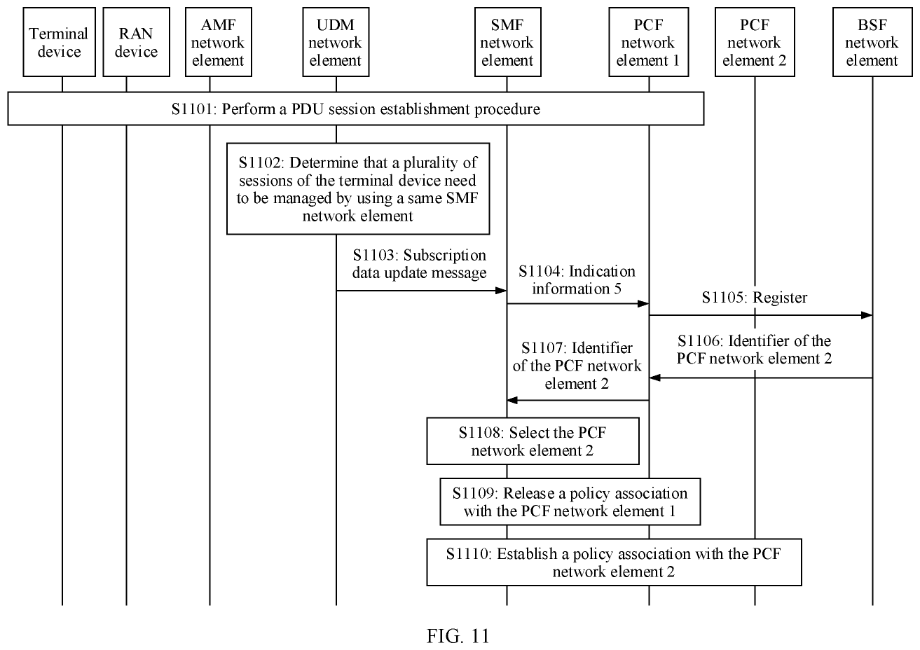

Optionally, for example, the communication system shown in FIG. 5 is used in the 5G network architecture in the non-roaming scenario shown in FIG. 6 or FIG. 7. FIG. 11 shows another subscription change processing method according to an embodiment of this application. The subscription change processing method includes the following steps.

S1101 and S1102: Steps S1101 and S1102 are the same as steps S1001 and S1002 in the embodiment shown in FIG. 10. For related descriptions, refer to the embodiment shown in FIG. 10. Details are not described herein again.

S1103: The UDM network element sends a subscription data update message to the SMF network element. Correspondingly, the SMF network element receives the subscription data update message from the UDM network element.

The subscription data update message carries indication information 4, and the indication information 4 indicates that the plurality of sessions of the terminal device need to be managed by using the same SMF network element. For related descriptions, refer to the embodiment shown in FIG. 10. Details are not described herein again.

Optionally, the indication information 4 in this embodiment of this application may also be referred to as first indication information. This is not specifically limited in this embodiment of this application.

Optionally, in this embodiment of this application, before the SMF network element receives the subscription data update message from the UDM network element, the SMF network element may send a second subscription request message to the UDM network element, where the second subscription request message is used to request to subscribe to a second event, and the second event is an event that subscription data of the terminal device changes. This is not specifically limited in this embodiment of this application.

Optionally, interaction between the UDM network element and one SMF network element is used as an example for description in FIG. 10. It should be understood that the plurality of sessions (namely, the plurality of sessions) that each have the attributes: the first DNN and the first S-NSSAI may be managed by using different SMF network elements. For a procedure of interaction between the UDM network element and another SMF network element, refer to step S1103. Details are not described herein again.

In step S1102 and step S1103, descriptions are provided by using an example in which the UDM network element sends the subscription data update message to the SMF network element after determining that the plurality of sessions of the terminal device need to be managed by using the same SMF network element. Alternatively, after determining that the plurality of sessions of the terminal device need to be managed by using the same SMF network element, the UDM network element may send, to an AMF network element, a subscription data update message carrying indication information 1. This is similar to step S903 in the embodiment shown in FIG. 9. Further, the AMF network element sends, to the SMF network element, the indication information 2 in step S904 in the embodiment shown in FIG. 9, so that the SMF network element learns that the subscription data of the terminal device changes to that the plurality of sessions of the terminal device need to be managed by using the same SMF network element. This is not specifically limited in this embodiment of this application. In this implementation, an SMF network element interacting with the AMF network element is any one of one or more SMF network elements corresponding to a session that has the attributes: the first DNN and the first S-NSSAI. Optionally, in this implementation, the SMF network element may send a third subscription request message to the AMF network element, where the third subscription request message is used to request to subscribe to a third event, and the third event is an event that subscription data of the terminal device changes. The AMF network element may send a fourth subscription request message to the UDM network element, where the fourth subscription request message is used to request to subscribe to a fourth event, and the fourth event is an event that the subscription data of the terminal device changes. This is not specifically limited in this embodiment of this application.

S1104: The SMF network element sends indication information 5 to a PCF network element 1. Correspondingly, the PCF network element 1 receives the indication information 5 from the SMF network element. The indication information 5 indicates that the plurality of sessions of the terminal device need to be managed by using the same SMF network element.

Optionally, the indication information 5 may be a special cause value. During implementation, the cause value may mean that a subscription changes to “the plurality of sessions of the terminal device need to be managed by using the same SMF network element”; the cause value may be a notification that is sent by the AMF network element to the SMF network element and that is of a subscription change: “the plurality of sessions of the terminal device need to be managed by using the same SMF network element”; or the cause value may indicate that PDU session re-establishment to a same DN is required (cause indicating that a PDU Session re-establishment to the same DN is required). This is not specifically limited in this embodiment of this application.

Optionally, the indication information 5 in this embodiment of this application may also be referred to as fourth indication information. This is not specifically limited in this embodiment of this application.

Optionally, in this embodiment of this application, before the PCF network element 1 receives the indication information 5 from the SMF network element, the PCF network element 1 may further send a first subscription request message to the SMF network element, where the first subscription request message is used to request a first event, and the first event is an event that the subscription data of the terminal device changes. This is not specifically limited in this embodiment of this application.

It should be understood that the indication information 4 and the indication information 5 may be the same, or may be different. This is not specifically limited in this embodiment of this application.

S1105: The PCF network element 1 registers with the BSF network element.

Optionally, the registration in step S1105 may be understood as re-registration or registration update. An objective of the registration is to obtain an identifier of a same PCF network element that serves a plurality of sessions that each have the attributes: the first DNN and the first S-NSSAI. This is uniformly described herein. Details are not described below again.

S1106: If the BSF network element detects that different PCF network elements are selected for the plurality of sessions that each have the attributes: the first DNN and the first S-NSSAI, an identifier of one of the PCF network elements is sent to the BSF network element. Herein, for example, an identifier of the selected one of the PCF network elements is an identifier of a PCF network element 2. In this case, the BSF network element sends the identifier of the PCF network element 2 to the PCF network element 1. Correspondingly, the PCF network element 2 receives the identifier of the PCF network element 2 from the BSF network element.

Optionally, in this embodiment of this application, when selecting the PCF network element from the PCF network elements corresponding to the plurality of sessions that each have the attributes: the first DNN and the first S-NSSAI, the BSF network element may select a PCF network element corresponding to a largest quantity of established sessions that each have the attributes: the first DNN and the first S-NSSAI. That is, a quantity of established sessions that correspond to the PCF network element 2 and that each have the attributes: the first DNN and the first S-NSSAI is not less than a quantity, recorded in the BSF network element, of established sessions that each have the attributes: the first DNN and the first S-NSSAI and that correspond to any other one of the PCF network elements corresponding to the plurality of sessions that each have the attributes: the first DNN and the first S-NSSAI. In this way, changes of PCF network elements corresponding to excessive sessions can be avoided to a greatest extent, so that a procedure is more optimized.

S1107: The PCF network element 1 sends the identifier of the PCF network element 2 to the SMF network element. Correspondingly, the SMF network element receives the identifier of the PCF network element 2 from the PCF network element 1.

S1108: The SMF network element selects, based on the identifier of the PCF network element 2, the PCF network element 2 to serve the session that has the attributes: the first DNN and the first S-NSSAI.

S1109: The SMF network element releases a policy association with the PCF network element 1. For details, refer to an existing implementation. Details are not described herein again.

It should be understood that, in this embodiment of this application, releasing a policy association is different from releasing a session. That is, the session may not be released when the policy association is released. This is uniformly described herein. Details are not described below again.

S1110: The SMF network element establishes a policy association with the PCF network element 2.

In a possible implementation, the PCF network element 1 may store, in a unified data repository (unified data repository, UDR) network element, context of a session that is of the terminal device and that is established by using the PCF network element 1. Further, that the SMF network element establishes a policy association with the PCF network element 2 may include: The PCF network element 2 obtains, from the UDR network element by using an identifier of the terminal device and a session identifier as keywords, the context of the session that is of the terminal device and that is established by using the PCF network element 1.

In another possible implementation, that the SMF network element establishes a policy association with the PCF network element 2 may include: The SMF network element reports, to the PCF network element 2, stored context of a session that is of the terminal device and that is established by using the PCF network element 1.

Optionally, in this embodiment of this application, after the SMF network element establishes the policy association with the PCF network element 2, the SMF network element may send a PCF ID of the selected PCF network element 2 to the AMF network element, so that the AMF network element records a mapping relationship between a PDU session identifier and the PCF ID of the PCF network element 2. This is not specifically limited in this embodiment of this application.

It should be understood that the foregoing merely provides two implementations, as examples, of establishing the policy association with the PCF network element 2 by the SMF network element. Certainly, the SMF network element may alternatively establish the policy association with the PCF network element 2 in another manner. This is not specifically limited in this embodiment of this application.

In steps S1106 to S1110, descriptions are provided by using an example in which the BSF network element selects a PCF network element different from the PCF network element 1. Certainly, the BSF network element may alternatively select the PCF network element 1. In this case, the BSF network element sends an identifier of the PCF network element 1 to the PCF network element 1. Correspondingly, the PCF network element 1 receives the identifier of the PCF network element 1 from the BSF network element. In this scenario, steps S1107 to S1110 do not need to be performed. This is uniformly described herein. Details are not described below again.

It should be understood that, in steps S1104 to S1110, descriptions are provided by using an example in which the PCF network element 1 is any PCF network element corresponding to the plurality of sessions that each have the attributes: the first DNN and the first S-NSSAI. In other words, when the plurality of sessions that each have the attributes: the first DNN and the first S-NSSAI correspond to a plurality of PCF network elements, for a processing manner of each PCF network element, refer to the processing manner of the PCF network element 1 in steps S1104 to S1110. This is uniformly described herein. Details are not described below again.

Based on the subscription change processing method provided in this embodiment of this application, after a session has been established, if subscription data of a terminal device is updated to that a plurality of sessions of the terminal device need to be managed by using a same SMF network element, the corresponding SMF network element may trigger, by using a PCF network element associated with the SMF network element, a BSF network element to reselect a PCF network element, to select a same PCF network element for the sessions that have same attributes: a same DNN and a same piece of S-NSSAI.

Actions of the UDM network element, the SMF network element, the PCF network element, or the BSF network element in steps S1101 to S1110 may be performed by the processor 801 in the communication device 800 shown in FIG. 8 by invoking the application program code stored in the memory 803. This is not limited in this embodiment.

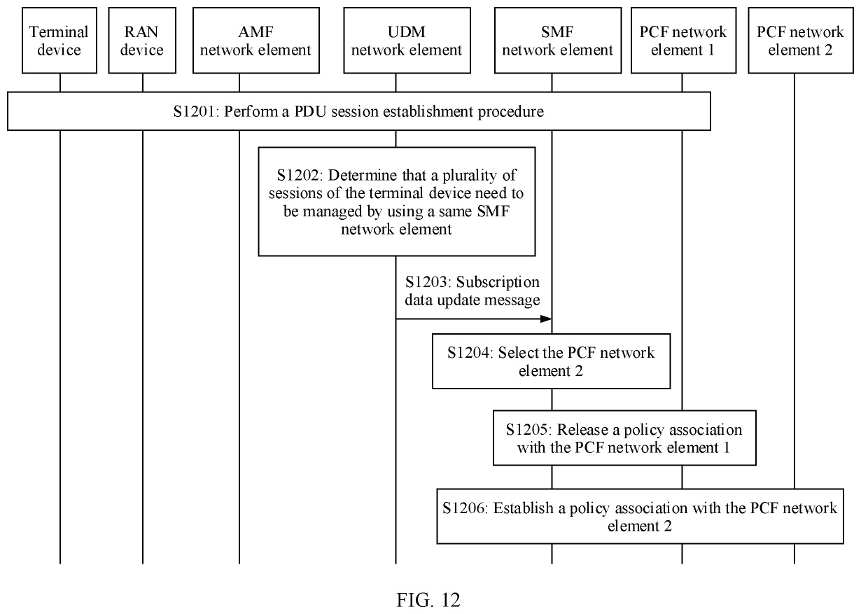

Optionally, the 5G network architecture in the non-roaming scenario shown in FIG. 6 or FIG. 7 is used as an example. FIG. 12 shows another subscription change processing method according to an embodiment of this application. The subscription change processing method includes the following steps.

S1201 to S1203: Steps S1201 to S1203 are the same as steps S1101 to S1103 in the embodiment shown in FIG. 11. For related descriptions, refer to the embodiment shown in FIG. 11. Details are not described herein again.

S1204: The SMF network element selects a PCF network element 2 to serve the plurality of sessions that each have the attributes: the first DNN and the first S-NSSAI.

When the SMF network element learns that the plurality of sessions of the terminal device need to be managed by using the same SMF network element, for an implementation in which the SMF network element selects the PCF network element 2 to serve the plurality of sessions that each have the attributes: the first DNN and the first S-NSSAI, refer to a conventional technology. Details are not described herein.

Optionally, in this embodiment of this application, when selecting a PCF network element, the SMF network element may select a PCF network element corresponding to a largest quantity of established sessions that each have the attributes: the first DNN and the first S-NSSAI. That is, a quantity of established sessions that correspond to the PCF network element 2 and that each have the attributes: the first DNN and the first S-NSSAI is not less than a quantity of established sessions that each have the attributes: the first DNN and the first S-NSSAI and that correspond to any other one of the PCF network elements corresponding to the plurality of sessions that each have the attributes: the first DNN and the first S-NSSAI. In this way, changes of PCF network elements corresponding to excessive sessions can be avoided to a greatest extent, so that a procedure is more optimized.

S1205 and S1206: Steps S1205 and S1206 are the same as steps S1109 and S1110 in the embodiment shown in FIG. 11. For related descriptions, refer to the embodiment shown in FIG. 11. Details are not described herein again.

It should be understood that, if the PCF network element 2 selected by the SMF network element is the same as the PCF network element 1, step S1205 may not be performed. That is, the SMF network element does not need to release the policy association with the PCF network element 1. This is uniformly described herein. Details are not described below again.

Based on the subscription change processing method provided in this embodiment of this application, after a session has been established, if subscription data of a terminal device is updated to that a plurality of sessions of the terminal device need to be managed by using a same SMF network element, the corresponding SMF network element may reselect a PCF network element, to select a same PCF network element for the sessions that have same attributes: a same DNN and a same piece of S-NSSAI.

Actions of the SMF network element or the UDM network element in steps S1201 to S1206 may be performed by the processor 801 in the communication device 800 shown in FIG. 8 by invoking the application program code stored in the memory 803. This is not limited in this embodiment.

It should be understood that the solution, provided in the embodiment shown in FIG. 9 or FIG. 10, that enables the same SMF network element to be selected for the sessions that have the same attributes: the same DNN and the same piece of S-NSSAI and the solution, provided in the embodiment shown in FIG. 11 or FIG. 12, that enables the same PCF network element to be selected for the sessions that have the same attributes: the same DNN and the same piece of S-NSSAI may be used in combination. For example, after learning that a plurality of sessions of a terminal device need to be managed by using a same SMF network element, an AMF network element may notify, in the manner in the embodiment shown in FIG. 9, an SMF network element other than an SMF network element 1 in a plurality of SMF network elements, so that the another SMF network element notifies, after releasing a corresponding session, the terminal device to re-establish a corresponding session. For the SMF network element 1, after the AMF network element notifies the SMF network element 1, the SMF network element 1 may select, in the manner in the embodiment shown in FIG. 11 or FIG. 12, the same PCF network element for the sessions that have the same attributes: the same DNN and the same piece of S-NSSAI. This is not specifically limited in this embodiment of this application. Optionally, as described in the embodiment shown in FIG. 9, the SMF network element 1 may be the SMF network element corresponding to the largest quantity of established sessions that each have the attributes: the first DNN and the first S-NSSAI. In this way, release and re-establishment of excessive sessions can be avoided to a greatest extent, so that a procedure is more optimized.

It may be understood that in the foregoing embodiments, the methods and/or the steps implemented by the first session management network element may alternatively be implemented by a component (for example, a chip or a circuit) that may be used in the first session management network element. The methods and/or the steps implemented by the first policy control network element may alternatively be implemented by a component (for example, a chip or a circuit) that may be used in the first policy control network element. The methods and/or the steps implemented by the unified data management network element may alternatively be implemented by a component (for example, a chip or a circuit) that may be used in the unified data management network element.

The foregoing mainly describes the solutions provided in embodiments of this application from a perspective of interaction between the network elements. Correspondingly, embodiments of this application further provide a communication apparatus. The communication apparatus may be the first session management network element in the foregoing method embodiments, an apparatus including the first session management network element, or a component that may be used in the first session management network element. Alternatively, the communication apparatus may be the first policy control network element in the foregoing method embodiments, an apparatus including the first policy control network element, or a component that may be used in the first policy control network element. Alternatively, the communication apparatus may be the unified data management network element in the foregoing method embodiments, an apparatus including the unified data management network element, or a component that may be used in the unified data management network element. It may be understood that, to implement the foregoing functions, the communication apparatus includes a corresponding hardware structure and/or software module for performing the functions. A person skilled in the art should be easily aware that, in combination with examples of units and algorithm steps described in embodiments disclosed in this specification, this application can be implemented by using hardware or a combination of hardware and computer software. Whether a function is performed by hardware or hardware driven by computer software depends on particular applications and design constraints of the technical solutions. A person skilled in the art may use different methods to implement the functions of each particular application, but it should not be considered that the implementation goes beyond the scope of this application.

For example, the communication apparatus is the first session management network element in the foregoing method embodiments. FIG. 13 is a schematic diagram of a structure of a first session management network element 130. The first session management network element 130 includes a receiving module 1301 and a sending module 1302. The receiving module 1301 may also be referred to as a receiving unit, and is configured to implement a receiving function. For example, the receiving module 1301 may be a receiver circuit, a receiver, a receiver, or a communication interface. The sending module 1302 may also be referred to as a sending unit, and is configured to implement a sending function. For example, the sending module 1302 may be a transmitter circuit, a transmitter, a transmitter, or a communication interface. Optionally, the receiving module 1301 and the sending module 1302 may be integrated into a transceiver module. This is not specifically limited in this embodiment of this application.

The receiving module 1301 is configured to receive first indication information, where the first indication information indicates that a plurality of sessions of a terminal device need to be managed by using a same session management network element, the plurality of sessions are a plurality of sessions that each have attributes: a first DNN and first S-NSSAI, and the first session management network element is one of a plurality of session management network elements corresponding to the plurality of sessions. The sending module 1302 is configured to send a session release notification to the terminal device, where the session release notification carries a first session identifier and second indication information, the second indication information indicates to re-establish a first session corresponding to the first session identifier, and the first session is a session that has the attributes: the first DNN and the first S-NSSAI.

Optionally, the receiving module 1301 is specifically configured to receive the first indication information from a unified data management network element, or receive the first indication information from a mobility management network element.

All related content of the steps in the foregoing method embodiments may be cited in function descriptions of the corresponding function modules. Details are not described herein again.

In this embodiment, the first session management network element 130 is presented in a form of function modules obtained through division in an integrated manner. The “module” herein may be a specified ASIC, a circuit, a processor and a memory that execute one or more software or firmware programs, an integrated logic circuit, and/or another component that can provide the foregoing functions. In a simple embodiment, a person skilled in the art may figure out that the first session management network element 130 may be in a form of the communication device 800 shown in FIG. 8.

For example, the processor 801 in the communication device 800 shown in FIG. 8 may invoke the computer-executable instructions stored in the memory 803, to enable the communication device 800 to perform the subscription change processing methods in the foregoing method embodiments.

Specifically, functions/implementation processes of the receiving module 1301 and the sending module 1302 in FIG. 13 may be implemented by the processor 801 in the communication device 800 shown in FIG. 8 by invoking the computer-executable instructions stored in the memory 803. Alternatively, functions and implementation processes of the receiving module 1301 and the sending module 1302 in FIG. 13 may be implemented by the communication interface 804 in the communication device 800 shown in FIG. 8.

The first session management network element 130 provided in this embodiment may perform the foregoing subscription change processing methods. Therefore, for technical effects that can be achieved by the first session management network element 130, refer to the foregoing method embodiments. Details are not described herein again.

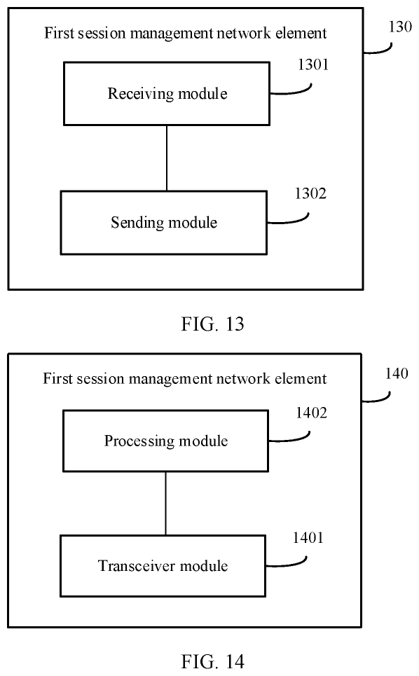

For example, the communication apparatus is the first session management network element in the foregoing method embodiments. FIG. 14 is a schematic diagram of a structure of a first session management network element 140. The first session management network element 140 includes a transceiver module 1401 and a processing module 1402. The transceiver module 1401 may also be referred to as a transceiver unit, and is configured to implement a transceiver function. For example, the transceiver module 1401 may be a transceiver circuit, a transceiver, a transceiver, or a communication interface.

The transceiver module 1401 is configured to receive first indication information, where the first indication information indicates that a plurality of sessions of a terminal device need to be managed by using a same session management network element, the plurality of sessions are a plurality of sessions that each have attributes: a first DNN and first S-NSSAI, and the first session management network element is one of a plurality of session management network elements corresponding to the plurality of sessions. The processing module 1402 is configured to release one or more policy associations with one or more policy control network elements associated with the first session management network element, and establish a policy association with a target policy control network element, where the one or more policy control network elements are one or more of a plurality of policy control network elements corresponding to the plurality of sessions, and the target policy control network element is a policy control network element reselected for one or more sessions that are established by using the one or more policy control network elements and that each have the attributes: the first DNN and the first S-NSSAI.

All related content of the steps in the foregoing method embodiments may be cited in function descriptions of the corresponding function modules. Details are not described herein again.

In this embodiment, the first session management network element 140 is presented in a form of function modules obtained through division in an integrated manner. The “module” herein may be a specified ASIC, a circuit, a processor and a memory that execute one or more software or firmware programs, an integrated logic circuit, and/or another component that can provide the foregoing functions. In a simple embodiment, a person skilled in the art may figure out that the first session management network element 140 may be in a form of the communication device 800 shown in FIG. 8.

For example, the processor 801 in the communication device 800 shown in FIG. 8 may invoke the computer-executable instructions stored in the memory 803, to enable the communication device 800 to perform the subscription change processing methods in the foregoing method embodiments.

Specifically, functions/implementation processes of the transceiver module 1401 and the processing module 1402 in FIG. 14 may be implemented by the processor 801 in the communication device 800 shown in FIG. 8 by invoking the computer-executable instructions stored in the memory 803. Alternatively, functions/implementation processes of the processing module 1402 in FIG. 14 may be implemented by the processor 801 in the communication device 800 shown in FIG. 8 by invoking the computer-executable instructions stored in the memory 803. Functions/implementation processes of the transceiver module 1401 in FIG. 14 may be implemented by the communication interface 804 in the communication device 800 shown in FIG. 8.

The first session management network element 140 provided in this embodiment may perform the foregoing subscription change processing methods. Therefore, for technical effects that can be achieved by the first session management network element 140, refer to the foregoing method embodiments. Details are not described herein again.

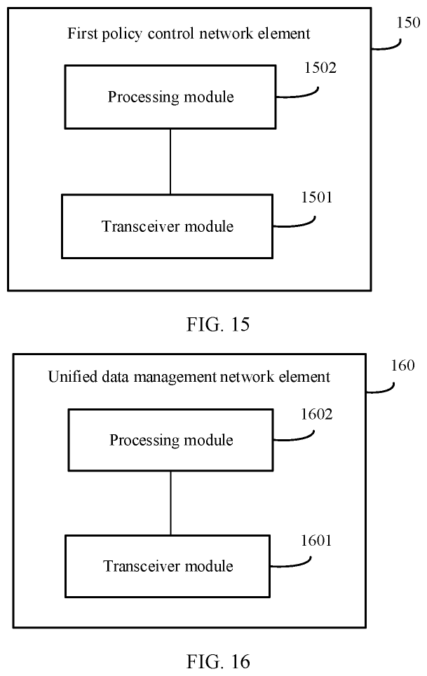

For example, the communication apparatus is the first policy control network element in the foregoing method embodiments. FIG. 15 is a schematic diagram of a structure of a first policy control network element 150. The first policy control network element 150 includes a transceiver module 1501 and a processing module 1502. The transceiver module 1501 may also be referred to as a transceiver unit, and is configured to implement a transceiver function. For example, the transceiver module 1501 may be a transceiver circuit, a transceiver, a transceiver, or a communication interface.

The transceiver module 1501 is configured to receive fourth indication information from a first session management network element, where the fourth indication information indicates that a plurality of sessions of a terminal device need to be managed by using a same session management network element, the plurality of sessions are a plurality of sessions that each have attributes: a first DNN and first S-NSSAI, the first session management network element is one of a plurality of session management network elements corresponding to the plurality of sessions, and the first policy control network element is one of a plurality of policy control network elements corresponding to the plurality of sessions. The processing module 1502 is configured to obtain an identifier of a second policy control network element from a binding support function network element. The transceiver module 1501 is further configured to send the identifier of the second policy control network element to the first session management network element, where the second policy control network element is a policy control network element selected for a session that has the attributes: the first DNN and the first S-NSSAI, and the identifier of the second policy control network element is used to indicate to reselect, to the second policy control network element, a policy control network element that serves a session that has the attributes: the first DNN and the first S-NSSAI.

All related content of the steps in the foregoing method embodiments may be cited in function descriptions of the corresponding function modules. Details are not described herein again.

In this embodiment, the first policy control network element 150 is presented in a form of function modules obtained through division in an integrated manner. The “module” herein may be a specified ASIC, a circuit, a processor and a memory that execute one or more software or firmware programs, an integrated logic circuit, and/or another component that can provide the foregoing functions. In a simple embodiment, a person skilled in the art may figure out that the first policy control network element 150 may be in a form of the communication device 800 shown in FIG. 8.

For example, the processor 801 in the communication device 800 shown in FIG. 8 may invoke the computer-executable instructions stored in the memory 803, to enable the communication device 800 to perform the subscription change processing methods in the foregoing method embodiments.

Specifically, functions/implementation processes of the transceiver module 1501 and the processing module 1502 in FIG. 15 may be implemented by the processor 801 in the communication device 800 shown in FIG. 8 by invoking the computer-executable instructions stored in the memory 803. Alternatively, functions/implementation processes of the processing module 1502 in FIG. 15 may be implemented by the processor 801 in the communication device 800 shown in FIG. 8 by invoking the computer-executable instructions stored in the memory 803. Functions/implementation processes of the transceiver module 1501 in FIG. 15 may be implemented by the communication interface 804 in the communication device 800 shown in FIG. 8.

The first policy control network element 150 provided in this embodiment may perform the foregoing subscription change processing methods. Therefore, for technical effects that can be achieved by the first policy control network element 150, refer to the foregoing method embodiments. Details are not described herein again.

For example, the communication apparatus is the unified data management network element in the foregoing method embodiments. FIG. 16 is a schematic diagram of a structure of a unified data management network element 160. The unified data management network element 160 includes a transceiver module 1601 and a processing module 1602. The transceiver module 1601 may also be referred to as a transceiver unit, and is configured to implement a transceiver function. For example, the transceiver module 1601 may be a transceiver circuit, a transceiver, a transceiver, or a communication interface.

The processing module 1602 is configured to determine that a plurality of sessions of a terminal device need to be managed by using a same session management network element, where the plurality of sessions are a plurality of sessions that each have attributes: a first DNN and first S-NSSAI. The transceiver module 1601 is configured to send fifth indication information, where the fifth indication information indicates that the plurality of sessions of the terminal device need to be managed by using the same session management network element.

Optionally, the transceiver module 1601 is specifically configured to send the fifth indication information to the mobility management network element.

Optionally, the transceiver module 1601 is further configured to receive a fourth subscription request message from the mobility management network element, where the fourth subscription request message is used to request to subscribe to a fourth event, and the fourth event is an event that subscription data of the terminal device changes.

Optionally, the transceiver module 1601 is specifically configured to send the fifth indication information to one or more session management network elements, where the one or more session management network elements are one or more of a plurality of session management network elements corresponding to the plurality of sessions.

Optionally, the processing module 1602 is further configured to determine that the plurality of sessions have been established by using a plurality of session management network elements.

Optionally, the transceiver module 1601 is further configured to receive a second subscription request message from the one or more session management network elements, where the second subscription request message is used to request to subscribe to a first event, and the second event is an event that the subscription data of the terminal device changes.

All related content of the steps in the foregoing method embodiments may be cited in function descriptions of the corresponding function modules. Details are not described herein again.

In this embodiment, the unified data management network element 160 is presented in a form of function modules obtained through division in an integrated manner. The “module” herein may be a specified ASIC, a circuit, a processor and a memory that execute one or more software or firmware programs, an integrated logic circuit, and/or another component that can provide the foregoing functions. In a simple embodiment, a person skilled in the art may figure out that the unified data management network element 160 may be in a form of the communication device 800 shown in FIG. 8.

For example, the processor 801 in the communication device 800 shown in FIG. 8 may invoke the computer-executable instructions stored in the memory 803, to enable the communication device 800 to perform the subscription change processing methods in the foregoing method embodiments.

Specifically, functions/implementation processes of the transceiver module 1601 and the processing module 1602 in FIG. 16 may be implemented by the processor 801 in the communication device 800 shown in FIG. 8 by invoking the computer-executable instructions stored in the memory 803. Alternatively, functions/implementation processes of the processing module 1602 in FIG. 16 may be implemented by the processor 801 in the communication device 800 shown in FIG. 8 by invoking the computer-executable instructions stored in the memory 803. Functions/implementation processes of the transceiver module 1601 in FIG. 16 may be implemented by the communication interface 804 in the communication device 800 shown in FIG. 8.

The unified data management network element 160 provided in this embodiment may perform the foregoing subscription change processing methods. Therefore, for technical effects that can be achieved by the unified data management network element 160, refer to the foregoing method embodiments. Details are not described herein again.

It should be noted that one or more of the foregoing modules or units may be implemented by using software, hardware, or a combination thereof. When any one of the foregoing modules or units is implemented by using software, the software exists in a form of computer program instructions, and is stored in a memory. A processor may be configured to execute the program instructions to implement the foregoing method procedures. The processor may be built in a SoC (system-on-a-chip) or an ASIC, or may be an independent semiconductor chip. In addition to a core configured to perform an operation or processing by executing software instructions, the processor may further include a necessary hardware accelerator, for example, a field programmable gate array (field programmable gate array, FPGA), a PLD (programmable logic device), or a logic circuit that implements a dedicated logic operation.

When the foregoing modules or units are implemented by using hardware, the hardware may be any one or any combination of a CPU, a microprocessor, a digital signal processing (digital signal processing, DSP) chip, a microcontroller unit (microcontroller unit, MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

Optionally, an embodiment of this application further provides a communication apparatus (for example, the communication apparatus may be a chip or a chip system). The communication apparatus includes a processor, configured to implement the method in any one of the foregoing method embodiments. In a possible implementation, the communication apparatus further includes a memory. The memory is configured to store necessary program instructions and data. The processor may invoke program code stored in the memory, to indicate the communication apparatus to perform the method in any one of the foregoing method embodiments. Certainly, the memory may alternatively not be located in the communication apparatus. When the communication apparatus is a chip system, the communication apparatus may include a chip, or may include the chip and another discrete component. This is not specifically limited in this embodiment of this application.

All or some of the foregoing embodiments may be implemented by using software, hardware, firmware, or any combination thereof. When a software program is used to implement embodiments, all or some of embodiments may be implemented in a form of a computer program product. The computer program product includes one or more computer instructions. When the computer program instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid state disk, SSD)), or the like.

Although this application is described with reference to embodiments herein, in a process of implementing this application that claims protection, a person skilled in the art may understand and implement another variation of the disclosed embodiments by viewing the accompanying drawings, disclosed content, and the appended claims. In the claims, “comprising” (comprising) does not exclude another component or another step, and “a” or “one” does not exclude a case of “a plurality of”. A single processor or another unit may implement several functions enumerated in the claims. Some measures are recorded in dependent claims that are different from each other, but this does not mean that the measures cannot be combined to produce a good effect.

Although this application is described with reference to specific features and embodiments thereof, it is clear that various modifications and combinations may be made to this application without departing from the spirit and the scope of this application. Correspondingly, the specification and accompanying drawings are merely example description of this application defined by the appended claims, and are considered as any of and all modifications, variations, combinations or equivalents that cover the scope of this application. It is clear that a person skilled in the art can make various modifications and variations to this application without departing from the spirit and the scope of this application. This application is intended to cover these modifications and variations of this application provided that they fall within the scope of the claims of this application and their equivalent technologies.

What is claimed is:

1. A subscription change processing method, comprising:
receiving, by a first session management network element, first indication information indicating that a plurality of sessions of a terminal device need to be managed by a same session management network element, wherein the plurality of sessions each have a first data network name (DNN) and first single network slice selection assistance information (S-NSSAI), and the plurality of sessions correspond to a plurality of session management network elements including the first session management network element; and
sending, by the first session management network element to the terminal device, a session release notification comprising a first session identifier and second indication information, wherein the second indication information indicates re-establishment of a first session corresponding to the first session identifier and having the first DNN and the first S-NSSAI.

2. The method according to claim 1, wherein the second indication information indicates that the plurality of sessions need to be managed by the same session management network element.

3. The method according to claim 1, wherein the step of receiving the first indication information comprises:
receiving, by the first session management network element from an access and mobility management function network element, a protocol data unit (PDU) session release request comprising the first indication information.

4. The method according to claim 1, wherein the first indication information comprises a session re-establishment indication.

5. The method according to claim 1, wherein the first indication information comprises a cause value.

6. The method according to claim 1, wherein the re-established session corresponding to the first session has a second session identifier different from the first session identifier.

7. A subscription change processing method, comprising:
establishing, by a terminal device, a plurality of sessions each having a first data network name (DNN) and first single network slice selection assistance information (S-NSSAI), the plurality of sessions being managed by a plurality of session management network elements;
receiving, by the terminal device from a first session management network element of the plurality of session management elements, a session release notification comprising a first session identifier and second indication information, wherein the second indication information indicates to re-establish a first session corresponding to the first session identifier, and the first session has: the first DNN and the first S-NSSAI; and
initiating, by the first terminal device based on the session release notification, a procedure of re-establishing a session corresponding to the first session such that the re-established session has same DNN and S-NSSAI as the first DNN and the first S-NSSAI and the re-established session is managed by a second session management network element which manages one or more sessions of the plurality of sessions.

8. The method according to claim 7, wherein the second indication information indicates that the plurality of sessions need to be managed by a same session management network element.

9. The method according to claim 7, wherein the initiating step comprises:
initiating a session establishment request for the session to be re-established, wherein the session establishment request comprises a second session identifier of the session to be re-established and the first session identifier, wherein the second session identifier is different from the first session identifier.

10. A session management network element, comprising:
a memory storing executable instructions;
a processor in communication with the memory, wherein the processor executes the executable instructions to cause the session management network element to perform the method steps of:
receiving first indication information indicating that a plurality of sessions of the terminal device need to be managed by a same session management network element, wherein the plurality of sessions correspond to a plurality of session management network elements, and the plurality of sessions each have a first data network name (DNN) and first single network slice selection assistance information (S-NSSAI); and
sending, to the terminal device, a session release notification comprising a first session identifier and second indication information, wherein the second indication information indicates re-establishment of a first session, the first session corresponding to the first session identifier and having the first DNN and the first S-NSSAI.

11. The session management network element according to claim 10, wherein the second indication information indicates that the plurality of sessions need to be managed by the same session management network element.

12. The session management network element according to claim 10, wherein the step of receiving the first indication information comprises:
receiving, from an access and mobility management function network element, a protocol data unit (PDU) session release request comprising the first indication information.

13. The session management network element according to claim 10, wherein the first indication information comprises a session re-establishment indication.

14. The session management network element according to claim 10, wherein the first indication information comprises a cause value.

15. The session management network element according to claim 10, wherein the re-established session corresponding to the first session has a second session identifier different from the first session identifier.

16. A terminal device, comprising:
a memory storing executable instructions;
a processor in communication with the memory, wherein the processor executes the executable instructions to cause the terminal device to perform the steps of:
establishing, by a terminal device, a plurality of sessions each having a first data network name (DNN) and first single network slice selection assistance information (S-NSSAI), the plurality of sessions being managed by a plurality of session management network elements;
receiving, from a first session management network element of the plurality of session management elements, a session release notification comprising a first session identifier and second indication information, wherein the second indication information indicates to re-establish a first session corresponding to the first session identifier, and the first session has: the first DNN and the first S-NSSAI; and
initiating, based on the session release notification, a procedure of re-establishing a session corresponding to the first session such that the re-established session has same DNN and S-NSSAI as the first DNN and the first S-NSSAI and the re-established session is managed by a second session management network element which manages one or more sessions of the plurality of sessions.

17. The terminal device according to claim 16, wherein the step of initiating the re-establishing the session comprises:
initiating a session establishment request for the re-established session, wherein the session establishment request comprises a second session identifier of the session to be re-established and the first session identifier, wherein the second session identifier is different from the first session identifier.

18. The terminal device according to claim 16, wherein the second indication information indicates that the plurality of sessions need to be managed by the same session management network element.
